(19) United States
(12) Patent Application Publication
(10) Pub. No.: US 2006/0142874 A1
(43) Pub. Date: Jun. 29, 2006

(54) System for reducing electrical wiring in complex apparatus, such as vehicles and aircraft

(76) Inventor: David D. Pettigrew JR., Dayton, OH (US)

Correspondence Address: David D. Pettigrew, Jr., 7520 Grovebrook Park, Dayton, OH, 45458, US

(21) Appl. No.: 11/020,957

(22) Filed: Dec. 23, 2004

(51) Int. Cl. G05B 15/00

(52) U.S. Cl. 700/1

(57) ABSTRACT

A system for controlling multiple processors, each of which controls a group of hardware devices. Each processor is equipped with storage space for a database. A single, shared, database circulates among the processors, and only a single processor receives the database at any given time. All processors are idle, except when the database arrives. Upon arrival, the receiving processor (1) reads data it needs from the database, (2) uses that data as input, (3) performs computation using the input, (4) produces output which is used to both (a) control its hardware and (b) add data to the database, (5) transfers the modified database to the next processor, and (6) becomes inactive. This sequence is repeated by all processors.

### BACKGROUND OF THE INVENTION

Electrical devices are present in many types of apparatus, such as motor vehicles, aircraft, and manufacturing facilities. Each electrical device receives power through electrical wires, and electrical switches are often interconnected in the wires, to control the devices.

Frequently, the switches are positioned at a central location, and the devices are distributed at numerous different locations, thus requiring a large amount of wiring, which depends largely on the distances between the switches and the devices. Of course, as the electrical devices increase in number, the amount of electrical wiring also increases.

In some instances, the amount of wiring is quite large. For example, testimony given in 1999 before the U.S. Congress indicates that a wide-body commercial transport aircraft can contain 200 miles of electrical wiring. This testimony is available on the Internet at
http://cf.alpa.org/internet/tm/tm091599.htm.

The Inventor herein has developed strategies to reduce the amount of wiring needed in aircraft, and other systems.

### SUMMARY OF THE INVENTION

In one form of the invention, high-voltage power, or high-current power, or both, are delivered locally to a controller which controls switches which deliver power to devices. The controller receives instructions from a remote supervisor as to which switches are to be actuated at a given time.

The instructions arrive in a database, which the controller copies, and then passes to other similar controllers. The controller may add content to the database, prior to passing on the database. The database continually circulates, and continually changes as the desired states of the switches change. With this arrangement, no long power cables need run from the remote supervisor to the controllers. The primary agency running from the supervisor is the database, which can be carried by a single data cable.

### BRIEF DESCRIPTION OF THE DRAWINGS

FIG. 1 illustrates four human controllers.

FIGS. 2 and 3 illustrate how a logic bit can control an electrical device.

FIGS. 4 and 5 illustrate how a single memory 24 can control the states of four devices, the devices being lamps 3, using a separate microprocessor for each lamp.

FIG. 6 illustrates how a single microprocessor can control two devices, based on a single memory.

FIG. 7 illustrates a single microprocessor controlling eight devices 30.

FIG. 8 is a flow chart illustrating logic implemented by the microprocessor in FIG. 7.

FIGS. 9 and 10 illustrate how the devices 30 of FIG. 7 can be driven into a different combination of states, by changing the mapping of data delivered to output pins of the microprocessor. Dashed arrows 83 and 86 illustrate the mappings.

FIG. 11 illustrates one architecture implemented by the invention.

FIG. 12 illustrates content of one type of database 130 utilized by the invention.

FIG. 13 illustrates the database 130 being passed from one processor 160 to another.

FIG. 14 illustrates the system of FIG. 11 after initialization.

FIG. 15 illustrates, in simple form, how the invention can be used in a vehicle.

FIG. 16 illustrates in greater detail the processors P of FIG. 15.

FIG. 17 illustrates content of another type of database 130 utilized by the invention.

FIG. 18 is an overview of one form of the invention.

FIG. 19 illustrates a more complex system of the type shown in FIG. 1.

FIG. 20 illustrates rules for the human controllers of FIG. 19.

FIG. 21 illustrates how mapping is implemented in one form of the invention.

FIG. 22 is a flow chart illustrating logic implemented by the apparatus of FIG. 21.

FIGS. 23 and 24 illustrate how mapping can be changed.

FIGS. 25 and 26 illustrate two forms of the invention.

FIG. 27 illustrates a master controller 130 utilized by one form of the invention.

FIGS. 28 and 29 illustrate two forms of the invention.

FIGS. 30, and 31 illustrate details of one form of the invention.

### DETAILED DESCRIPTION OF THE INVENTION

This discussion will progressively explain several embodiments of, and principles used by, the invention, beginning with simple examples.

FIG. 1 illustrates one basic concept behind the invention, and shows four human controllers C1-C4, together with 32 electrical switches S1-S32. Each switch connects to electrical wiring (not shown), which leads to electrical devices (not shown), controlled by the switches.

Each human controller C1-C4 is responsible for a respective group G1-G4 of the switches. Each controller C1-C4 is given a list L, and all lists L are identical. The lists tell the controllers how to position each switch. For example, the list L may read as follows:

LIST

S1 - ON
S2 - OFF
S3 - ON
. . .
S32 - ON

The list states that switch S1 should be ON, S2 should be OFF, and so on. Each controller C1-C4 reads the list L, and positions the switches in his group G1-G4 according to the list L.

This discussion will now explain how the switches can be positioned according to a list, but without human involvement.

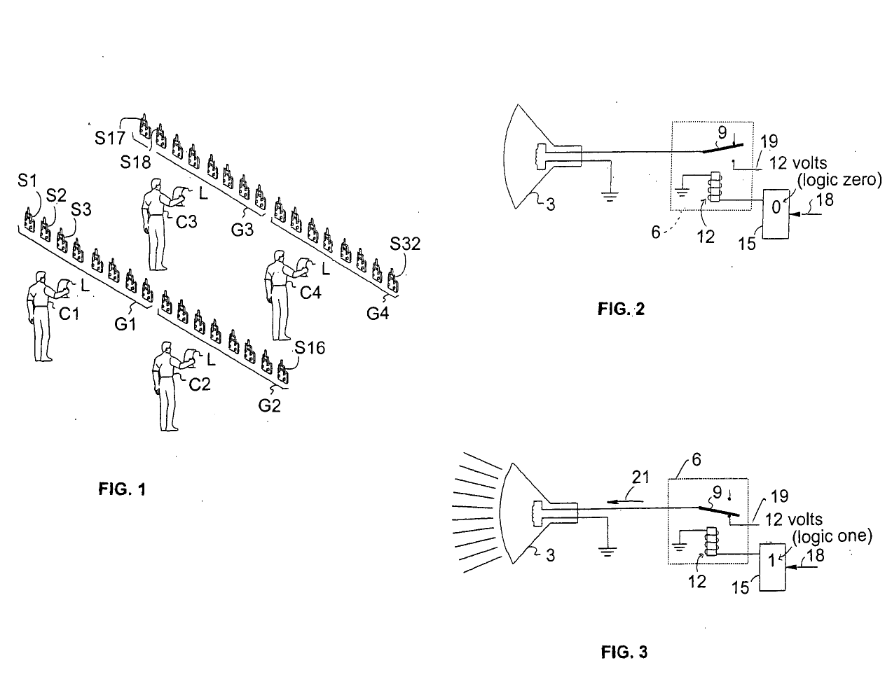

FIG. 2 shows an electric lamp 3, such as an automobile headlight. Relay 6 corresponds to a switch S in FIG. 1. Relay 6 contains a switch reed 9, the position of which is controlled by an electromagnet 12. Block 15 represents a latching driver circuit, known in the art, which receives an ordinary digital logic signal on input line 18. The latching driver circuit 15 latches that input signal, which may be a ONE or a ZERO, and, if necessary, amplifies the voltage, current, or both, if required to power the electromagnet 12.

As indicated in FIG. 2, the latching driver circuit 15 has received a logic ZERO, and is latching that ZERO. No voltage is applied to coil 12 in the relay 6, and so the lamp 3 is not connected to the 12 volt power supply 19.

In contrast, in FIG. 3, the latching driver circuit 15 has received a logic ONE, and is latching that ONE, as indicated. The latching driver circuit 15 applies a voltage to the electromagnet 12, which pulls reed 9 to the position shown, causing a current 21 to flow. The lamp 3 becomes illuminated, because it is now connected to the 12 volt power supply 19.

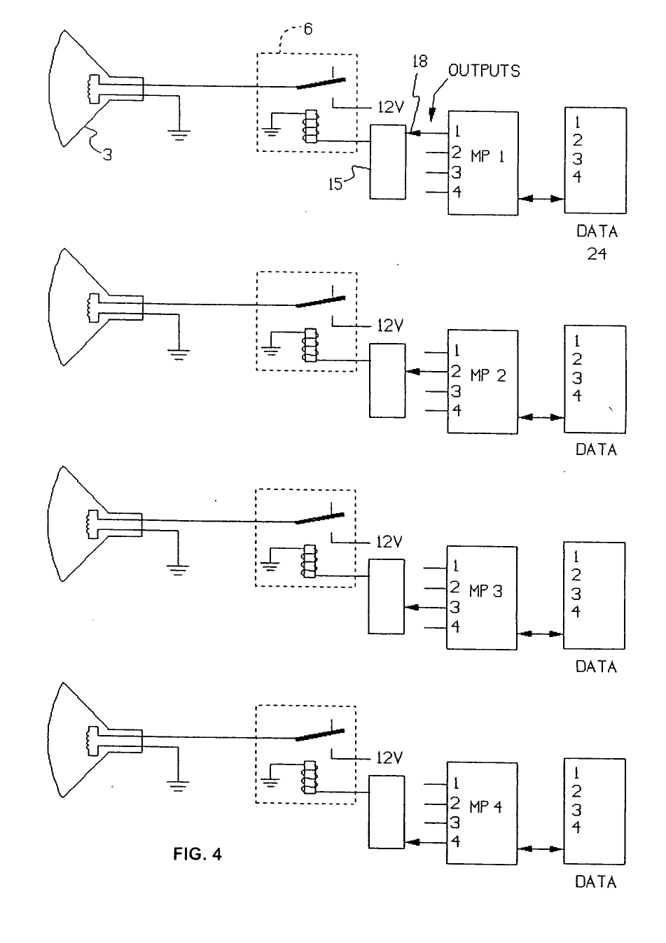

FIG. 4 shows four of the apparatus of FIG. 3, each individually controlling one of the four separate lamps 3. FIG. 4 shows four microprocessors MP1-MP4, each having four output pins, labeled 1-4. Each latching driver circuit 15 receives its input 18 from a different output pin of a microprocessor MP.

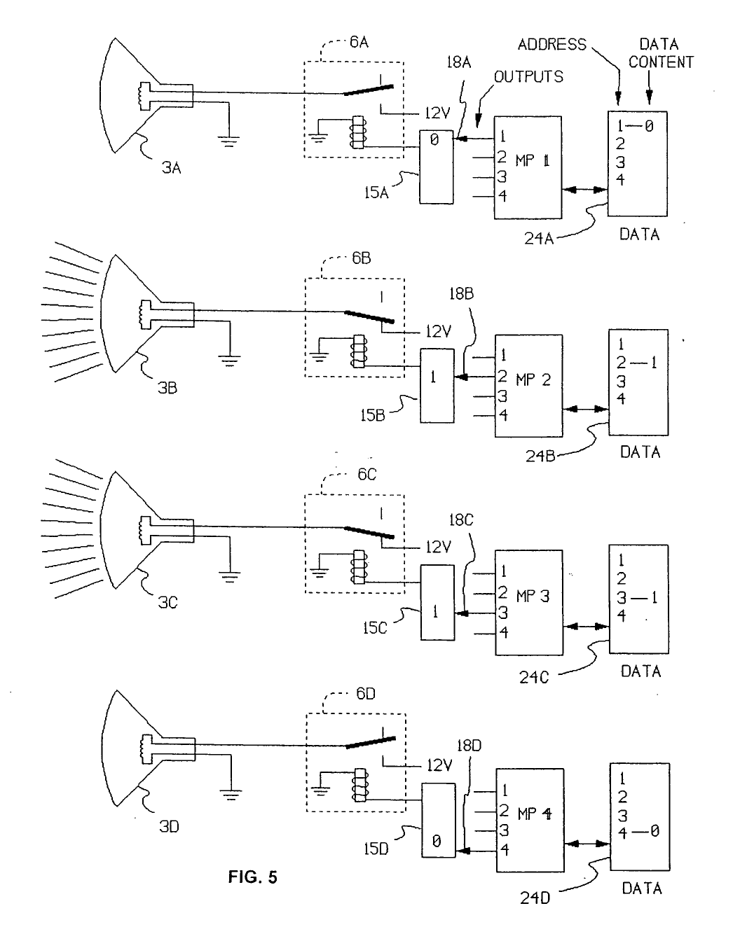

In FIG. 4, each microprocessor is given access to a memory 24, labeled DATA. Each memory 24 contains memory addresses 1-4, as indicated. Each memory address 1-4 corresponds to one of the output pins 1-4, and thus to one of the lamps 3, as will be explained in connection with FIG. 5. While each microprocessor MP has access to all four memory addresses 24, each microprocessor only uses a single address, as will be explained. In one form of the invention, all memories 24 are identical in content.

In FIG. 4, the microprocessors MP correspond to the human controllers C of FIG. 1. The memories 24 in FIG. 4 correspond to the lists L of FIG. 1.

FIG. 5 illustrates how the apparatus of FIG. 4 can control the four different lamps 3A-3D. The basic rule is twofold: (1) if a latching driver circuit 15 receives a ONE as input, it closes its associated relay 6, and illuminates its lamp; (2) on the other hand, if a latching driver circuit 15 receives a ZERO as input, its associated relay 6 remains open, and the associated lamp remains dark.

Each processor MP1-MP4 is assigned one address in memory 24. In FIG. 5, the assignments are as follows: (MP1, address 1), (MP2, address 2), (MP3, address 3), (MP4, address 4). Each processor transfers the content of its assigned address 24 to the output pin connecting to the latch 15. Thus, in FIG. 5, the following conditions occur.

The memory 24A of microprocessor MP1 contains a ZERO at address 1. Microprocessor MP1 writes that ZERO to the output pin 1 connecting to latching driver circuit 15A. Relay 6A remains open. Lamp 3A remains dark.

The memory 24B of microprocessor MP2 contains a ONE at address 2. Microprocessor MP2 writes that ONE to the output pin 2 connecting to latching driver circuit 15B. Relay 6B is thereby closed, causing lamp 3B to illuminate.

The memory 24C of microprocessor MP3 contains a ONE at address 3. Microprocessor MP3 writes that ONE to the output pin 3 connecting to latching driver circuit 15C. Relay 6C is thereby closed, causing lamp 3C to illuminate.

The memory 24D of microprocessor MP4 contains a ZERO at address 4. Microprocessor MP4 writes that ZERO to the output pin 4 connecting to latching driver circuit 15D. Relay 6D remains open. Lamp 3D remains dark.

Therefore, FIG. 5 illustrates how the illumination status of lamps 3A-3D can be controlled by the logic bits contained at addresses 1-4 in memories 24A-D.

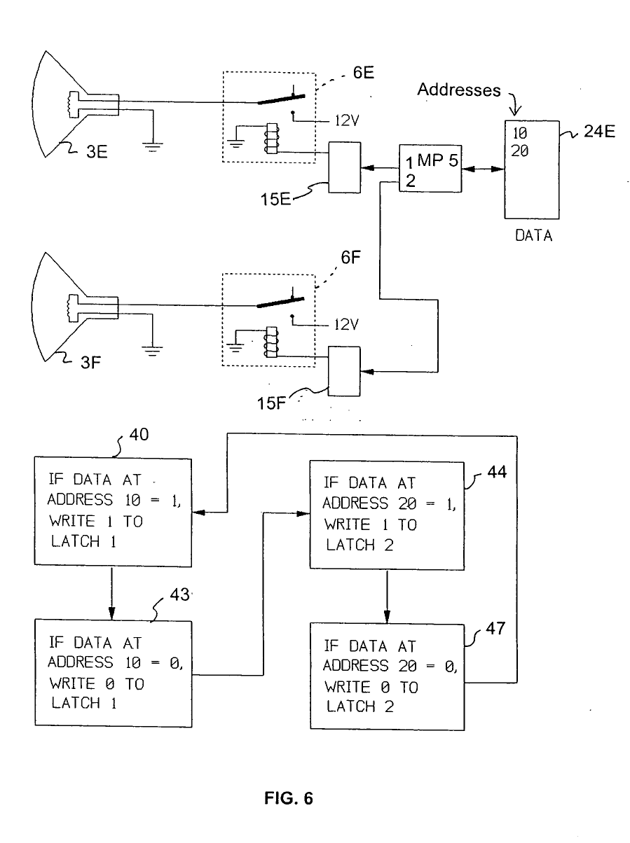

In the discussion above, each microprocessor controlled only a single relay, such as microprocessor MP1 in FIG. 5 controlling relay 6A. However, a single microprocessor can control more than one relay, or other device. FIG. 6 illustrates a single microprocessor MP1 controlling two relays 6E and 6F. The bits (not shown) which control the illumination status of lamps 3E and 3F are stored at addresses 10 and 20 in memory 24E.

Blocks 40, 43, 44, and 47 illustrate a logic loop executed by the microprocessor MP5 in controlling the lamps 3E and 3F. Block 40 inquires whether the data stored at address 10 in memory 24E is ONE. If so, microprocessor MP5 writes a ONE to latching driver 15E, closing relay 6E, thereby illuminating lamp 3E.

Block 43 inquires whether the data stored at address 10 in memory 24E is ZERO. If so, microprocessor MP5 writes a ZERO to latching driver 15E. The ZERO opens relay 6E. Lamp 3E becomes dark.

Block 44 inquires whether the data stored at address 20 in memory 24E is ONE. If so, microprocessor MP5 writes a ONE to latching driver 15F. The ONE closes relay 6F, thereby illuminating lamp 3E.

Block 47 inquires whether the data stored at address 20 in memory 24E is ZERO. If so, microprocessor MP5 writes a ZERO to latching driver 15F. The ZERO opens relay 6F. Lamp 3F becomes dark.

The logic is executed continually, as indicated by the arrows connecting blocks 40, 43, 44, and 47. If a data bit stored in memory 24E is changed, then the illumination status of the corresponding lamp 3 is also changed, immediately after that changed bit is read from memory 24E.

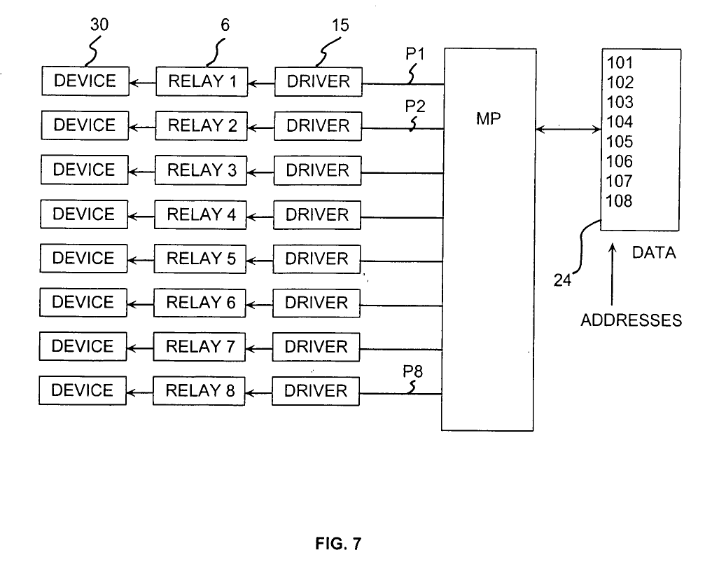

FIG. 7 illustrates a general case. Microprocessor MP contains eight output pins P1-P8. Each output pin leads to a DRIVER 15 which leads to a RELAY 6, which controls a DEVICE 30. Of course, as stated above, drivers 15 may not be necessary.

In the previous examples, the DEVICE used was an electrical lamp. However, the DEVICEs can be any device controllable by an electrical switch, including switches such as the RELAYs shown.

The switches are not limited to relays, but can take the form of transistors or other devices which control output voltage or current in response to an electrical input signal.

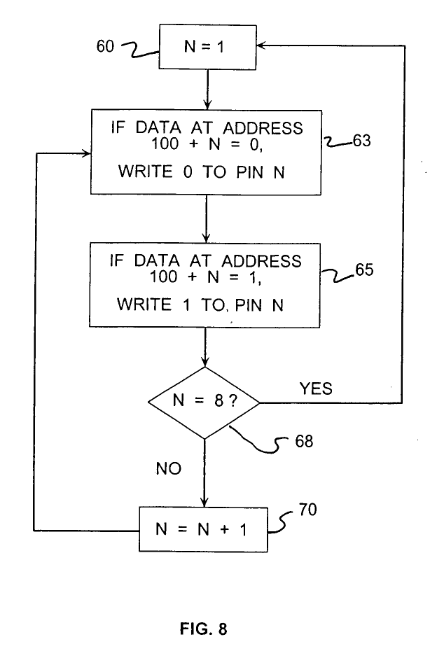

FIG. 7 shows eight addresses 101-108 contained in memory 24. FIG. 8 is a flow chart illustrating a program which microprocessor MP in FIG. 7 can utilize in connection with memory 24, to control the DEVICEs in FIG. 7. That program, in effect, transfers the bits in memory 24 in FIG. 7 to the output pins P1, P2, . . . P8 of the microprocessor MP. Further, the transfer follows a pattern: the bit at address 101 is transferred to pin P1; the bit at address 102 is transferred to pin P2, and so on.

In block 60 in FIG. 8, an index N is initialized to unity. With N presently set at unity, blocks 63 and 65 read the data bit in memory 24 in FIG. 7 at address 100+1, namely, address 101. If that bit is ZERO, then block 63 causes the microprocessor MP to write a ZERO to pin N, which is pin P1 in this example. If that bit is ONE, then block 64 causes the microprocessor MP writes a ONE to pin N, which is, again, pin P1 in this example.

Decision block 68 inquires whether index N has reached a value of eight. If not, the NO branch is taken, the index N is incremented in block 70, and the logic returns to block 63. If index N has reached eight, the YES branch is taken, the logic returns to block 60, wherein index N is re-initialized to unity.

The overall effect of the program of FIG. 8 is to copy the data bits contained in memory 24 in FIG. 7 from address 101 to pin P1, from address 102 to pin P2, and so on to address 108, which is written to pin P8.

Many microprocessors are designed so that their output pins hold the data which is written to them. If for some reason the data is not held by a given microprocessor, then latches can be added to the DRIVERs in FIG. 7.

FIGS. 7 and 8 illustrated how a single microprocessor can be used to control eight devices, such as lamps, based on data contained in memory 24. However, in this apparatus, the correspondence, or mapping, between the memory locations 101 et seq. and the output pins P1 et seq. was fixed, because the programming of FIG. 8 was fixed.

Fixed programming is not required however, the mapping can be changed if desired. In one approach to changing the mapping, a new program can be loaded into the microprocessor MP. For example, the number “100” in blocks 63 and 65 in FIG. 8 can be changed to “200” in a new program, thereby causing memory addresses 201-208 in memory 24 in FIG. 7 to control the lamps in FIG. 7.

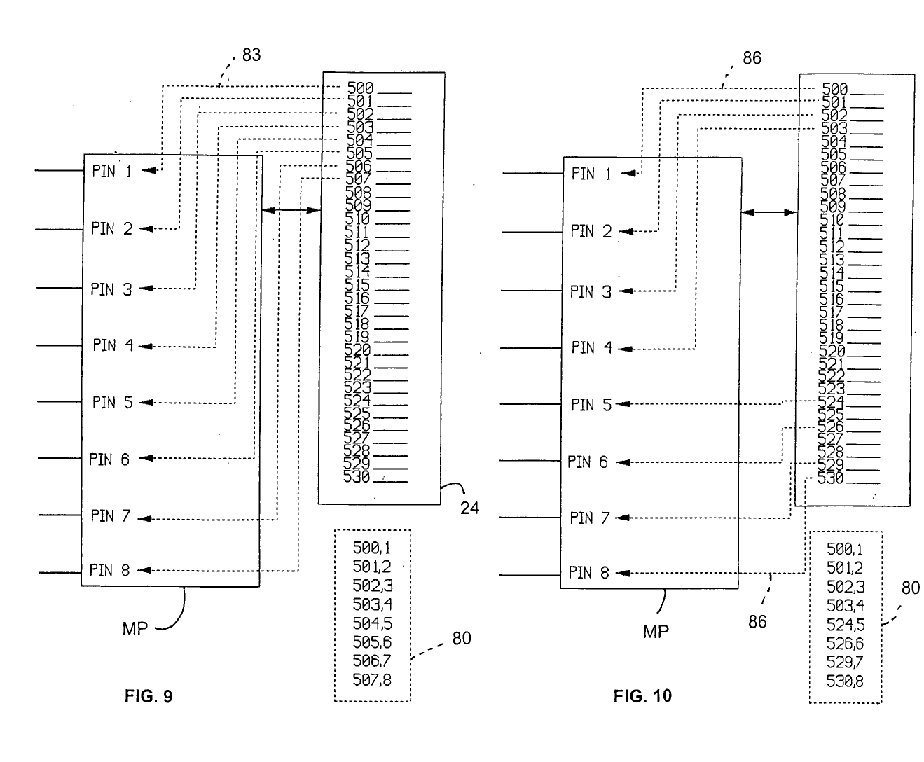

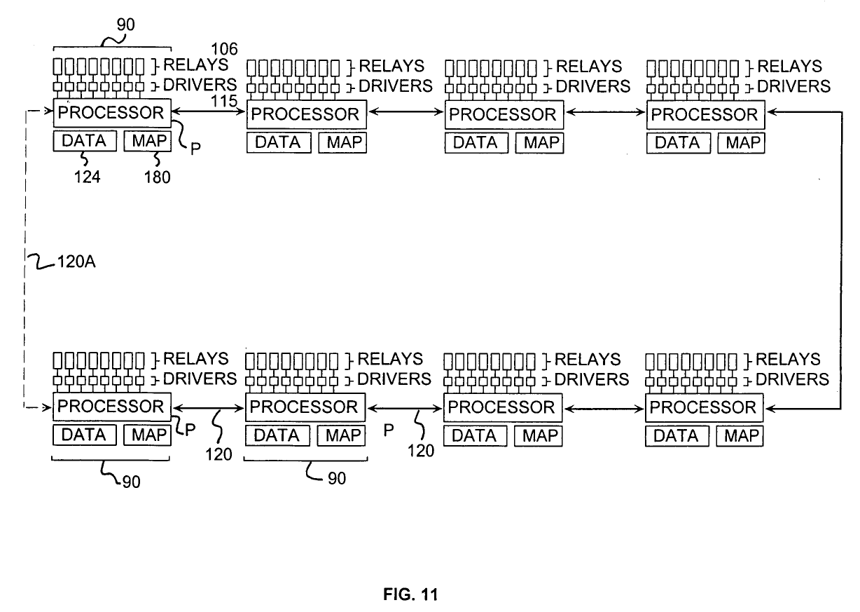

FIGS. 9 and 10 illustrate another approach which eliminates the requirement of loading a new program. FIG. 9 illustrates a microprocessor MP and its associated memory 24. In addition, mapping data 80 is stored in other memory accessible to the microprocessor MP. That mapping data 80 is loaded into memory when needed, as explained later.

This particular mapping data 80 contains the data pairs (500,1), (502,2) and so on. The first element of a data pair indicates a memory address, and the second element indicates the output pin to which to write the data located at that address. These particular data pairs tell the microprocessor that the bits stored at addresses 500 through 507 are to be written to output pins P1-P8, respectively.

Arrows 83 indicate graphically the mapping indicated by mapping data 80. It is known in the art how to write a program which writes the data in memory 24, as instructed by mapping data 80.

FIG. 10 illustrates how a different mapping can be implemented. Mapping data 80 has now changed in content. Arrows 86 illustrate graphically the mapping.

Under the arrangement of FIGS. 9 and 10, the memory addresses which control each output pin of the microprocessor MP can be changed by the mapping data 80 or 86.

One example of the usefulness of the system of FIGS. 9 and 10 can be found in the context of automotive lighting. Assume that the DEVICEs 30 in FIG. 7 are lights on a motor vehicle. Assume that the memory 24 in FIG. 7 is replaced by memory 24 in FIG. 9.

FIG. 9, when viewed with FIG. 7, indicates that a specific combination of vehicle lights are actuated, based on the data mapping 80 in FIG. 9. That is, the data bits contained at addresses 500-507 in memory 24 control the lamps connected to output pins 1-8, respectively. A data bit of ONE causes a lamp to illuminate, and a data bit of ZERO leaves a lamp dark. The particular combination of illuminated lamps, dictated by mapping data 80, may be suitable for dark rainy weather.

However, a different combination of illuminated lamps, such as that of FIG. 10, may be desired at night, during clear weather. Thus, if one uses microprocessor MP in FIGS. 9 and 10 to control the lights, one would load either mapping data 80 in FIG. 9, or mapping data 86 of FIG. 10, to change the configuration of illuminated lights.

The Inventor observes that the mapping data 80 can also be used to write data into memory 24, to thereby change the data located at the memory addresses which are mapped as indicated in FIG. 9. For example, each data-pair, such as “500,1,” shown in mapping data 80, can be replaced with a data triplet, such as “500,1,0.” That triplet would mean that (1) the data bit at address 500 is to be transferred to output pin 1 and (2) the data bit at address 500 is to be set to zero.

FIG. 11 illustrates one form of the invention, wherein eight structures 90 are connected together, by communication links 120. In one form of the invention, the structures 90 are identical in the sense that they all contain identical hardware and programming, Thus, when an article using the invention is manufactured, identical structures 90 are installed at various points throughout the article. Later, the content of the data 124 and the maps 180 will be supplied.

Additional communication link 120A can be added, to provide a ring topology, in the network sense.

The structures 90 operate as described above: each memory 124 contains data bits at addresses, and each processor copies those bits to its output pins, as instructed by the map 180. As explained above, the map 180 can be changed, and one approach to changing the map 180 will be discussed.

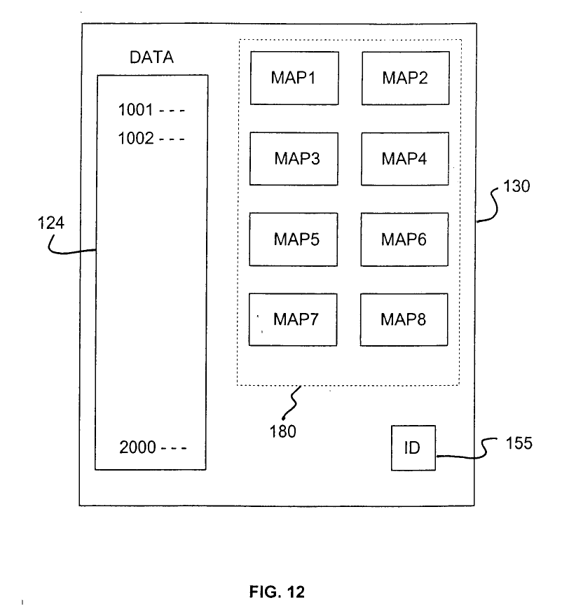

The combination of the memory 124 and the map 180 will be termed a database herein. FIG. 12 illustrates schematically the database 130, which contains data 124 and mapping data 180. The mapping data is subdivided into groups, labeled MAP1, MAP2, and so on. Each group corresponds to a specific processor P in FIG. 11. Each processor P contains an identity code 155 which identifies itself, and uses that code to determine which group to use.

For example, assume that the identity code is stored at memory address 1100 (not shown) in each memory 124 in FIG. 11. When a processor is to use the database 130, in FIG. 12 the processor first reads the identity code at address 1100, to learn its identity. If the processor learns that it is processor number 3, it then reads mapping data MAP3 in FIG. 12.

In FIG. 12, each address, such as 1001, is followed by dashed lines, indicating the data stored at that address. As explained above, the data (indicated by dashed lines) indicates how corresponding RELAYs in FIG. 11 are to be controlled.

In addition, the database 130 in FIG. 12 contains an identification code 155, labeled ID. This code 155 is used to create the identity code just described, and will be explained shortly.

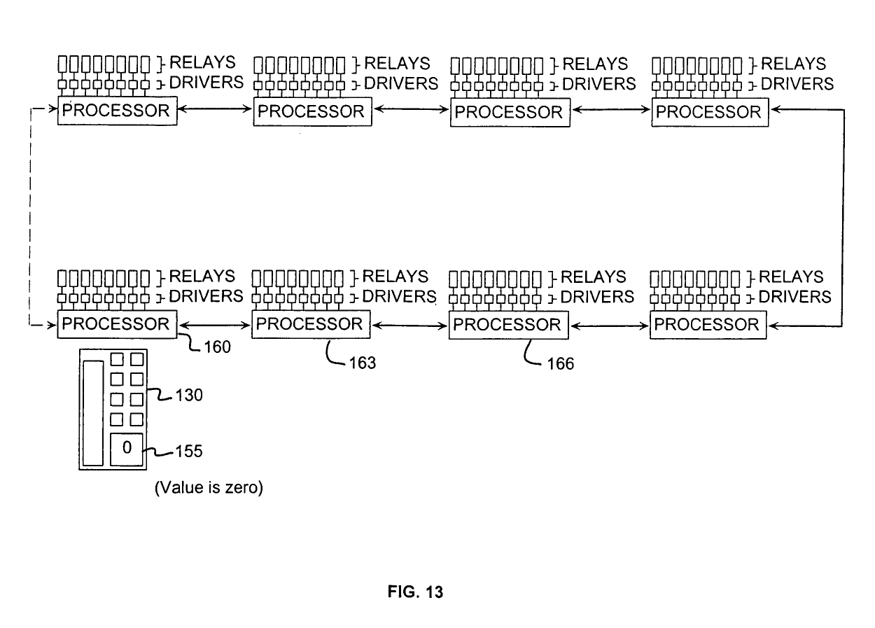

FIG. 13 illustrates how the database 130 is used in one form of the invention. The database 130 is delivered to processor 160 from an external source, such as a portable computer (not shown). The value of the ID code 155 upon delivery is zero, as indicated.

Processor 160 receives the database 130, then increments the ID code 155 to unity, and stores the database 130 in memory. Then processor 160 transmits the database 130 to processor 163, which does the same: processor 163 increments the ID code 155 to two, stores the database 130, and passes the database 130 to the next processor 166.

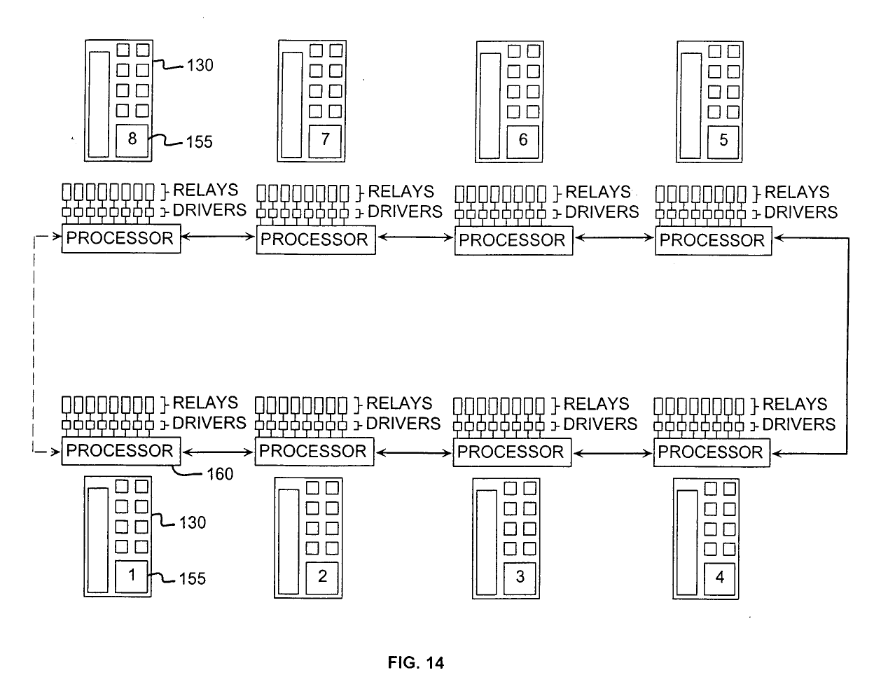

FIG. 14 shows the overall result. Each processor now has access to a copy, or instance, of the database 130, because database 130 is stored in each processor. All copies of the database 130 are identical, with the exception of the ID code 155. The ID code 155 is different for each processor, and each processor has acquired a unique ID code 155 running from 1 to 8. That was accomplished because each processor received a given ID code 155, incremented it by one, and used the incremented code as its own ID code. It passed the database 130, with the incremented ID code 155, to the next processor which repeated the process.

One purpose of the ID code is to allow identical, interchangeable, units 90 in FIG. 11 to be used. The identical units 90 are identified by their physical location, in sequence along the data lines 120. Their physical location in sequence (eg, 1, 2, 3 . . . 8) is indicated by the ID code 155. The process, described above, of incrementing the ID code 155 as the database 130 is passed from processor to processor causes each processor to be assigned an ID code 155 which corresponds to the processor's position in sequence.

One advantage of this approach is that an identity code need not be burned into each processor when the processor is manufactured, although this could be done. Instead, identical processors can be used, and the identity code is determined when the database 130 is first received.

Therefore, as so far explained, a database 130 in FIG. 12 is generated. It contains data 124, at addresses such as 1001, 1002, etc. That data indicates how electrical switches should be positioned. The database 130 also contains mapping data groups MAP1, MAP2 . . . MAP8. Each group corresponds to a single processor, and that correspondence is determined by the ID code 155 (or by a code otherwise installed in each processor).

The mapping data MAP1, MAP2, etc., in FIG. 12 tells the respective processors which addresses in memory 124 in FIG. 12 are to be copied to the output pins of the processors. Dashed arrows 86 in FIG. 10 illustrate the mapping graphically.

The database 130 in FIG. 14 can change over time, and the frequency of changes depends on the particular system in which the database 130 is being used. For example, if the system is an automobile, and the database 130 indicates desired status of components such as lights, door locks, powered windows, the frequency may be several times per second. For instance, a given processor in FIG. 14 may be assigned to monitor a headlamp switch, in the dashboard of a car, and under control of the driver. When the switch calls for full headlights, that processor detects that event, modifies the database 130 accordingly, and initiates circulation of the modified database 130. All processors replace their current copies of the database with the modified database 130, and respond to the modified database 130 as appropriate.

The Inventor points out that, in the embodiment of FIG. 14, every processor has access to the entire memory 124 in the database 130 of FIG. 12, even though every processor does not necessarily need the entire contents of the memory 124. This complete access provides increased flexibility as will be explained later.

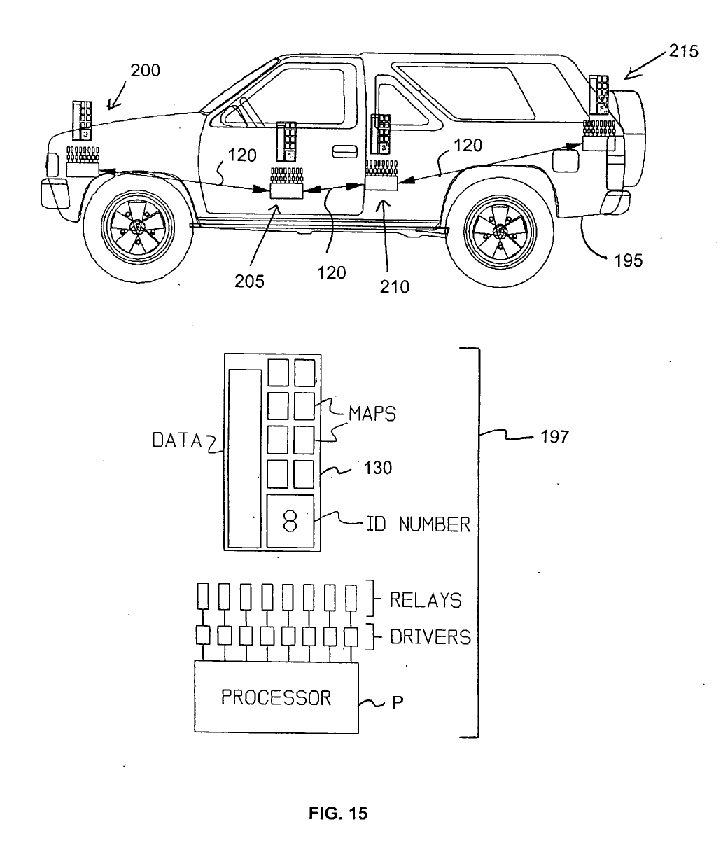

FIG. 15 provides a concrete example of usage of the system of FIG. 14. An automobile 195 is shown. An apparatus 197 is also shown, which contains a processor P and the database 130. The database 130 is copied into memory accessible to the processor P, but that is not explicitly shown, to emphasize the discrete nature of the database 130. The processor controls DRIVERS, which control RELAYS, as explained above.

The automobile 195 contains four such apparatus 197, labeled 200, 205, 210, and 215. The latter are connected by communication links 120. Apparatus 200 is assigned the function of controlling headlights, parking lights, fog lights, and turn signals. Apparatus 205 is assigned the function of controlling electric door locks, electric door windows, and courtesy illumination in the doors.

Apparatus 210 controls electric windows, environmental air temperature, and electric fan speed, for the center seat of the automobile 195. Apparatus 215 controls rear lights, including rear running lights, rear turn signals, and back-up lighting.

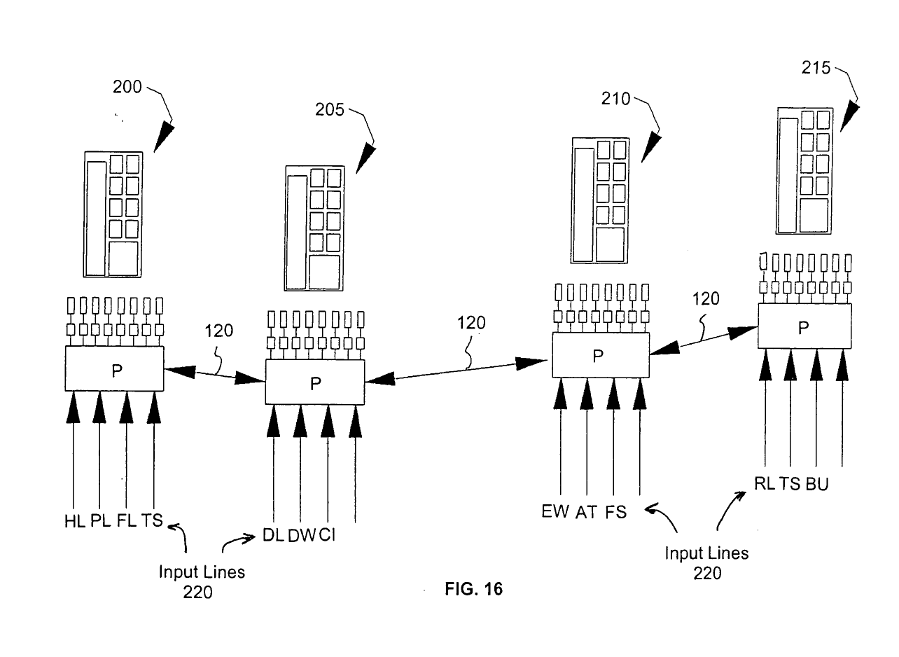

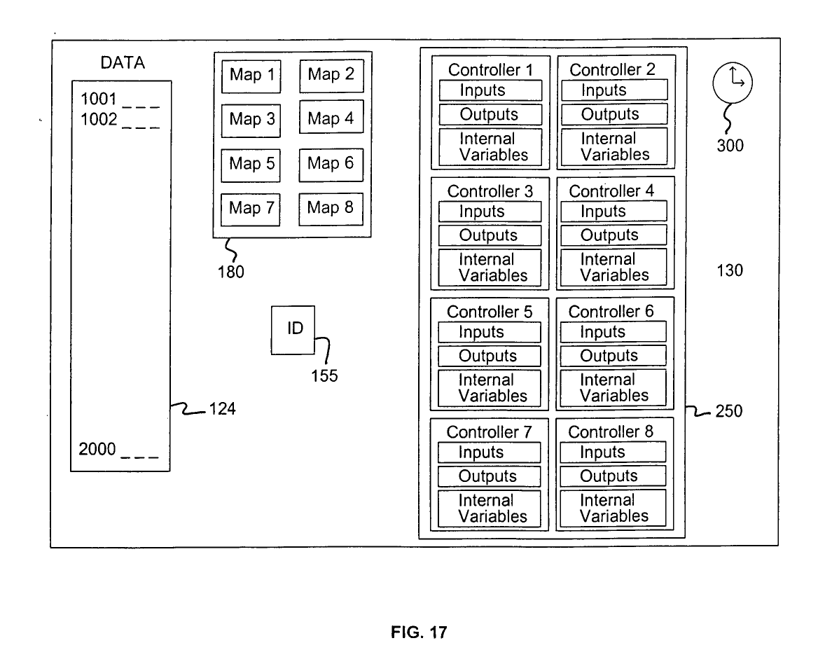

FIG. 16 is a rendition of part of FIG. 15, showing only the apparatus 200, 205, 210, and 215. In addition, input lines 220, not previously discussed, to the processors P are shown.

The processors receive the inputs indicated in the following Table:

TABLE

| Input | Origin |
|---|---|
| HL | Headlight switch |
| PL | Parking light switch |
| FL | Fog light switch |
| TS | Turn signal switch |
| DL | Door lock switch |
| DW | Door window switch |
| CI | Courtesy light |
| EW | Electric Window switch |
| AT | Air Temperature thermostat switch |
| FS | Fan speed switch |
| RL | Rear light switch |
| TS | Rear turn signal switch |
| BU | Back-up light switch |

Each processor reads the signal created by a switch, and loads the signal into the memory 124. Thus, the memory 124 in the database 130 in FIG. 12 indicates the positions of all relevant switches in the automobile 195 in FIG. 15. All processors have access to that database 130, and learn of changed switch positions, after copies of a new database 130 reach them.

The inputs 220 in FIG. 16 to the processors P need not be single-bit-type. Analog-to-digital conversion can be done, so that an analog signal, such as that produced by a potentiometer (not shown) can be converted to a digital signal, which would be received on multiple input lines 220. The multi-bit data can be stored in the database 130.

The preceding discussion has considered the database 130 in FIG. 12 as containing (1) data in memory 124, (2) mapping data for each processor, such as mapping data MAP1, and (3) the ID code 155. (Item (2) mapping data and item (3) ID code are both optional.) The database 130 can also contain additional information, as indicated in FIG. 17.

The logic states of the input and output pins of each controller, or processor, are indicated in the database 130, as indicated in block 250. In addition, the states of internal variables in the processors can be recorded, as indicated. Internal variables can reside in buffers in processors, and can contain, for example, scratch pad data.

The database 130 may contain a clock 300, which indicates actual time-of-day, or another type of time useful to the processors, such as for synchronization.

Of course, in some systems, certain data may be secret, so that some of the data indicated in FIG. 17 may be suppressed, and not made available to some, or all processors.

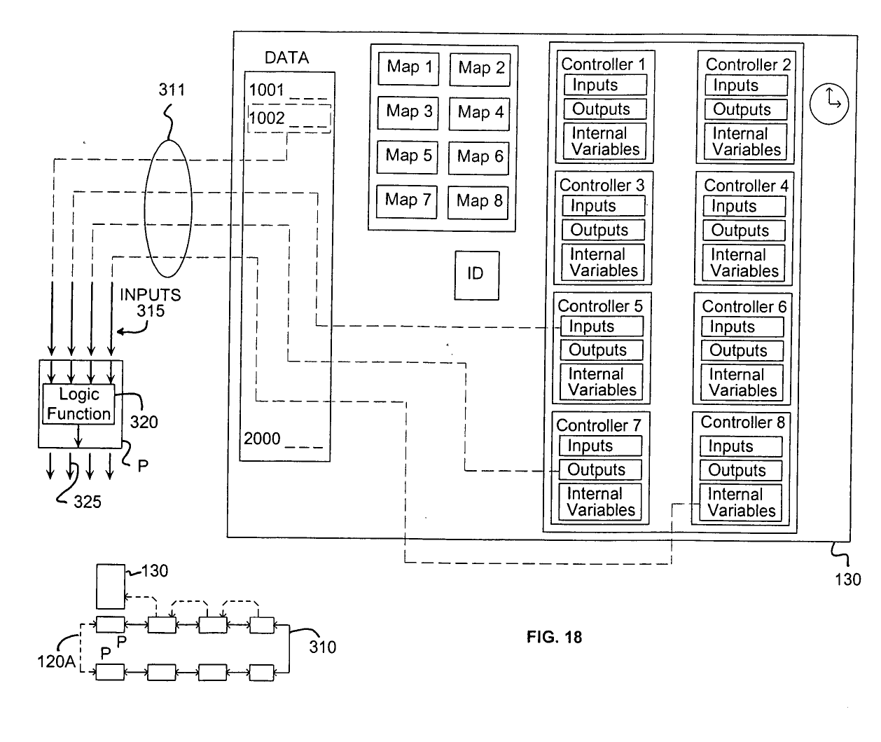

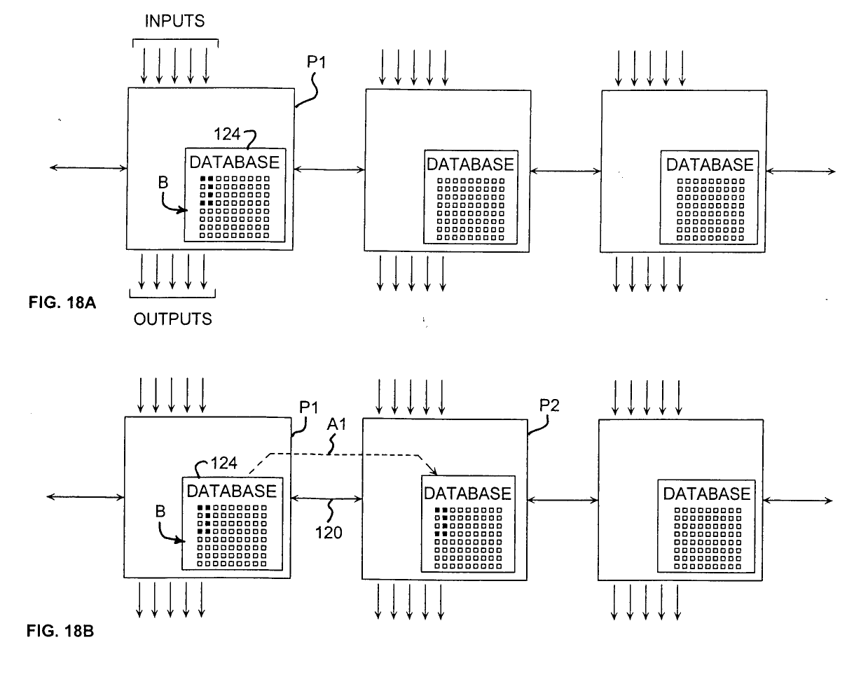

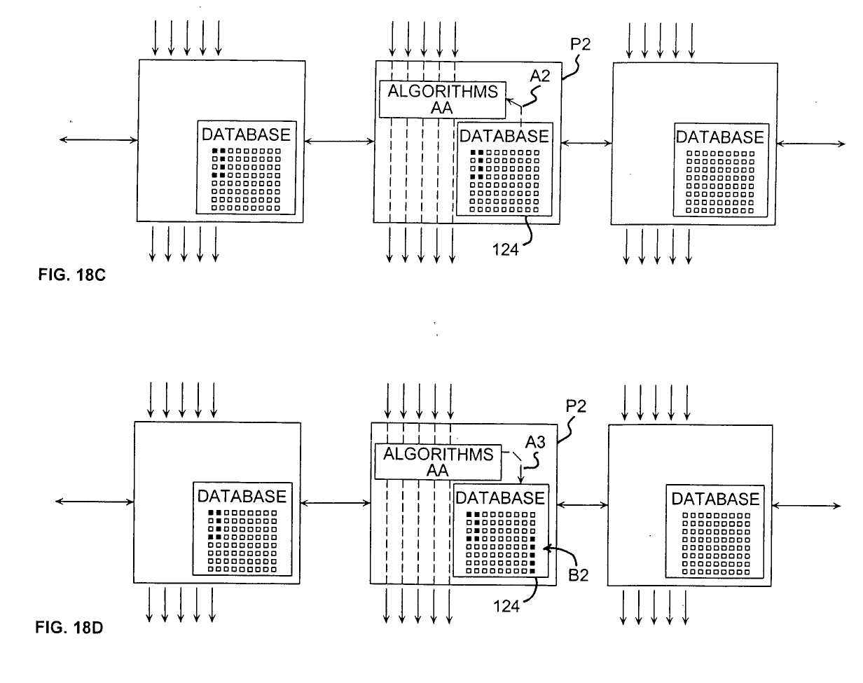

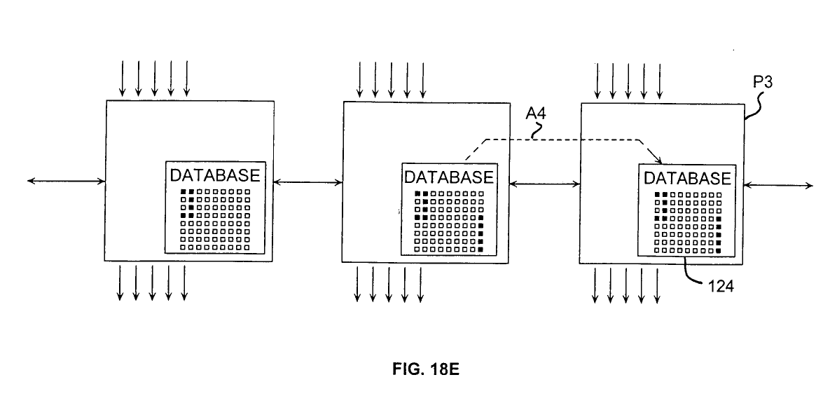

FIG. 18 is an overview of one form of the invention. In image 310, the database 130 continually circulates among the processors P, as indicated. Since the database 130 changes as time progresses, the circulation allows all processors P to obtain a current database.

If link 120A is present, the database 130 can circulate in a ring. If link 120A is not present, the database 130 can travel from one end of the linear chain of processors to the other, and then return, in which a ring-type topology is implemented. In general, any network topology can be used.

In the Figure, one of the processors P, and the database 130, are illustrated in enlarged form. In the discussion above, it was stated that the logic states of output pins of a processor were each determined by a bit in memory. However, in the general case, each processor is equipped with a logic function 320 for each of its output pins.

The logic function 320 is, in general, a Boolean function, equation, algorithm, or other process which receives inputs and produces an output in response, for an output pin. The logic function 320 indicates how selected data within the database, or elsewhere, is mapped onto each output pin. As explained above, the logic function, or mapping, is delivered to each processor in the database 130, in the blocks labeled MAP1, MAP2, etc. The logic functions can be static or they can change over time, and the database 130 delivers the changed logic functions to the processors.

FIG. 18 illustrates an exemplary mapping of inputs to output pin 325. Four inputs are delivered to the logic function 320, as indicated by the dashed arrows 311. One input is the data stored at address 1002. The second input is one of the inputs to processor, or controller, number 5. The third input is one of the outputs of controller number 7. The fourth input is one of the internal variables of controller number 8.

Logic function 320 processes the inputs, and delivers the output to output pin 325.

In one form of the invention, the database 130 contains a summary of the collected states of a system. For example, the database 130 in FIG. 17 contains data 124 to be used by processors and mapping functions 180. The database 130 also contains a report of all input pins, output pins, and internal variables of all other processors.

The data about the other processors will indicate significant information about the system. For example, if temperature is to be controlled, then a temperature sensor will provide an input to some processor. The database 130 makes that temperature input available to all other processors. In general, most, if not all, measured system parameters will be applied as inputs to some processor, and thereby become part of the shared database 130.

The logic function 320 in FIG. 18 allows any processor to compute a selected algorithm, using any of the system variables in the database 130 as inputs.

The contents of the database 130 can change. FIGS. 18A-18E illustrate one example. In FIG. 18A, the database 124 is contained in processor, or controller, P1. Dark blocks B indicate data items. In FIG. 18B, the database 124 is transferred to processor P2, as indicated by dashed arrow A1.

In FIG. 18C, processor P2 reads some of the data within the database 124 and delivers the data to algotirhms AA, as indicated by dashed arrow A2.

In FIG. 18D, the algorithms AA deliver output to the database 124, as indicated by dashed arrow A3. The output added to the database is indicated by dark blocks B2. The database 124 is transferred to processor P3 in FIG. 18E, as indicated by dashed arrow A4, and the procedure continues as just described.

A comparison of FIGS. 18A with FIG. 18D indicates that the database 124 has changed. The database stored by processor P2 in FIG. 18D is different from that stored in FIG. 18A. This change illustrates a general operating principle: each processor (1) receives a database, (2) utilizes content of the database, (3) perhaps adds content to the database, and (4) transfers the database, with the new content, to another processor. The added content will be utilized by another processor in the system.

Thus, to repeat, in the general case, the content of the database may change, as the database is passed from processor to processor.

Additional Considerations

1. De-bouncing can be performed. It is well known that, as switch contacts close, even at small voltages, the electric field generated between the contacts becomes progressively greater. For example, if the potential difference between two contacts is 12 volts, then if the contacts are one millimeter apart, the electric field is 12/0.001, or 12,000 volts/meter. As the contacts become closer and closer, the electric field becomes larger, and eventually exceeds the dielectric breakdown strength of the material between the contacts, which is generally air.

When breakdown occurs, intermittent arcing occurs between the contacts, with each arc acting as a short circuit. This phenomenon is termed “contact bounce,” because electronic circuitry connected to the contacts perceives the succession of arcs as repeated bouncing of two mechanical contacts against each other.

The invention can handle contact bounce in the following manner. When an initial contact, due to arcing, is detected on an input line, the processor receiving that input line sets a temporary flag, such as a bit at memory location A. Then, a predetermined interval later, such as 10 or 100 milliseconds, the processor looks at the input line again. If contact is again detected, the processor sets another flag, as at memory location B.

The processor then looks at memory locations A and B. If both flags are set, the processor concludes that the input has gone high, and then writes a bit to the address in memory 124 corresponding to that input line, indicating that the switch has closed.

The inventor points out that this particular sequence of setting flags A and then B is used because the processor, in general, only examines the input line for one, or a few, clock cycles. The examination thus takes a few nanoseconds. A single examination, lasting a few nanoseconds, cannot distinguish between a permanent switch closure, and a bounce. That is, an arc of duration of a few nanoseconds and a permanent switch closure are both detected as a switch closure during the examination time. However, two examinations, with sufficient time between them, can indicate, to a high degree of certainty, when bounce has terminated, and full closure has been achieved.

A similar process can be used to detect switch opening, as opposed to closure.

2. The logic function 320 in FIG. 18 can operate over time. For example, it may accept a collection of inputs at a given time T1. Then it may accept another collection of inputs at a later time T2. The output depends on both collections of inputs. The de-bouncing of Additional Consideration number 1, above, provides an example.

3. In one embodiment, one processor acts as a master, and controls the database 130. All other processors merely follow instructions provided in the database 130, but give no instructions themselves. For example, a collection of lights in a vehicle may be controlled by switches on a panel at the driver's, or pilot's, station. Those switches act as inputs to the master processor. The master processor generates the database 130, which indicates the switch positions. Other processors control the lights, based on the database. But the other processors do not issue instructions to the database, although they may indicate the status of the lights.

In one implementation of this embodiment, a single database is circulated by the master processor to the others. The contents of that database do not change, and all contents remain identical except when changed by the master processor.

4. In one embodiment, the database 130 arrives at a processor, the processor copies the database into memory, and passes the database to the next processor. However, another approach may be desirable in certain situations.

Assume that a processor A in the dashboard of a vehicle controls the lights. Assume that a processor B in the door of a vehicle controls a door lock. Assume that a light switch changes state, and also that a door-lock-button changes state.

Processor A generates a new database, and transmits it to processor B. However, if processor B copied that database into memory, processor B would over-write the data indicating the door-lock-button status. That data would be lost.

One solution would be that processor B compares the incoming database with processor B's existing database, and only copies differences. This could be done, but is time-consuming.

A preferred solution is that the database is divided into two parts. One part contains data which is under control of processor B. The second part contains the rest of the database. When the new database arrives, processor B copies only the second part into its database. Then processor B transmits a copy of that latter database (containing the copied second part, and the non-copied part which is under B's control) to its neighbor. The other processors operate in a similar manner.

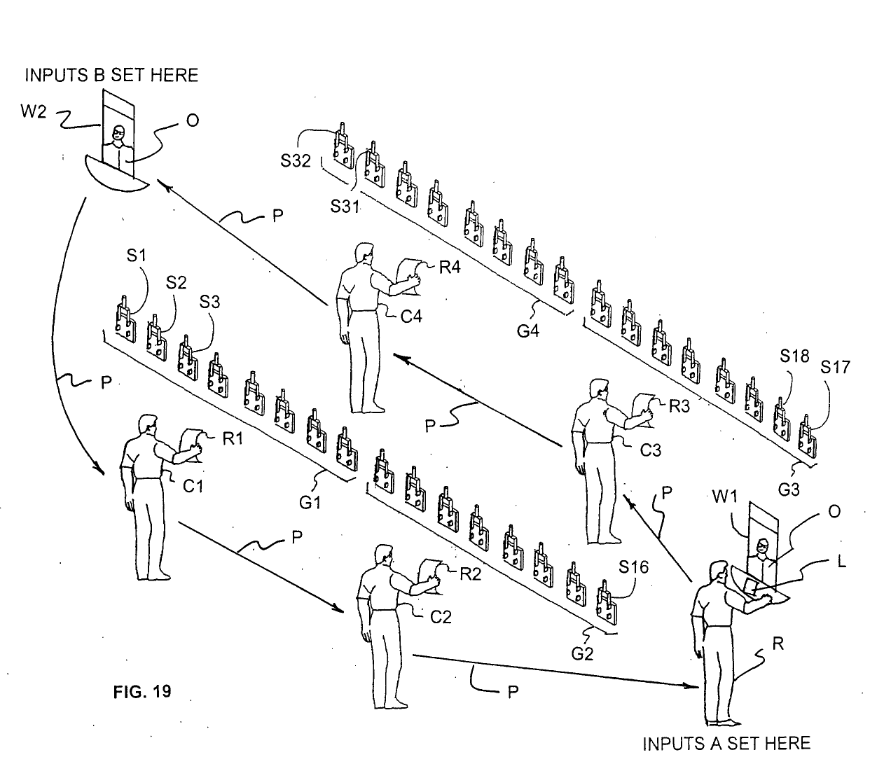

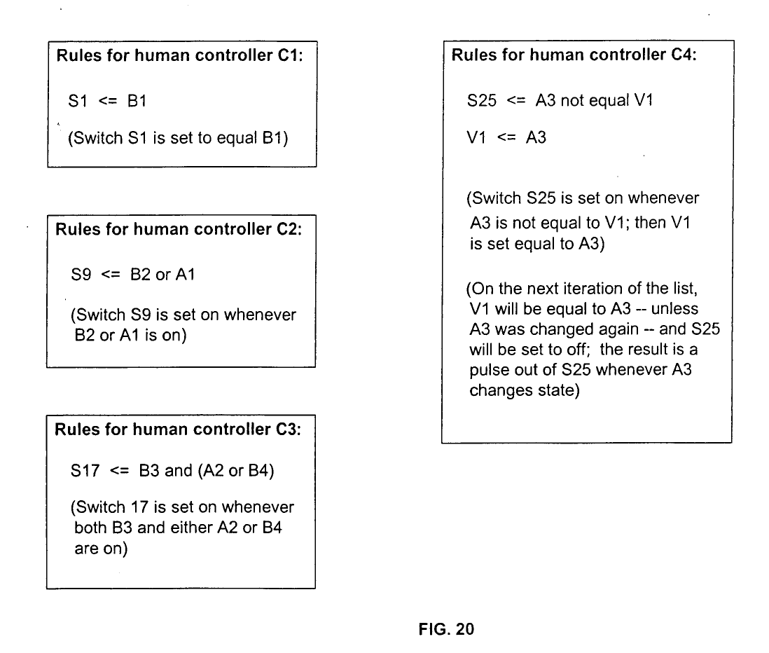

5. FIGS. 19 and 20 extend the explanation of the invention previously given with reference to FIG. 1.

FIG. 19 adds 2 different elements and changes one element from those in FIG. 1. The four identical lists L in FIG. 1 have been changed into one list L in FIG. 19 and a runner R has been added to carry the list L around from one human controller to the next in sequence from C1 to C2 and so on, designated as path P.

Also two windows W1 and W2 have been added with an operator O in each window; each operator O can change or modify the information on the list L when the list is presented to her by the runner. The operator O in each window W1-W2 makes changes according to inputs that she receives from outside the system.

These changes will result in the human controllers C1-C4 changing the position of their respective switches S1-S32. The runner R serves to circulate the list L continuously between the controllers C1-C4 and the operators O in the windows W1-W2. From this we can see that changes from operators O in windows W1-W2 (inputs) are carried through to changes in the switches S1-S32 (outputs).

In addition, four different sets of rules R1-R4 have been added in FIG. 20, one set of rules for each human controller C1-C4. The operation of each controller will now be governed by the rules R1-R4 applicable to each controller. In the earlier examples, each human controller C1-C4 simply checked his list to determine the setting shown for each of his switches and then set each switch accordingly. Now each human controller C1-C4 must apply the rules to the information on his list to determine the setting for each of his switches.

Controller C1 uses the set of rules R1, shown in FIG. 20, to determine the settings for his switches S1-S8. His rules R1 state that Switch S1 must be set according to the value of B1 (which was set by the operator O in window W1). Controller C2 uses the set of rules R2 to determine the settings for his switches S9-S16. According to his rules R2, controller C2 will set S9 on if either A1 is on or B2 is on. (Note that A1 was set by the operator O in window W1 and B2 was set by the operator in window W2.) This could be a demand to turn the air conditioning on if the operator in either window receives a request for air conditioning.

Likewise controller C3 uses his set of rules R3 to determine that switch S17 should be set on if B3 is on and either A2 or B4 is also on. In similar fashion, persons familiar with the art can define any logical rule or set of rules to determine the settings of the switches S1-S32 (outputs).

With controller C4, the rules introduce a new element. A controller can set intermediate variables on the list L as well as the switches in his area. When controller C4 evaluates his set of rules R4, he first checks to see if A3 is not equal to V1; if that is true, he sets S25 on. Then controller C4 sets the value of V1 equal to the value of A3. Note that on the next iteration of the list L, A3 will equal V1 and he will set S25 off; this will result in a pulse from S25 whenever A3 changes. Here we see that intermediate variables can be used together with the logic rules and the inputs to determine the setting of an output.

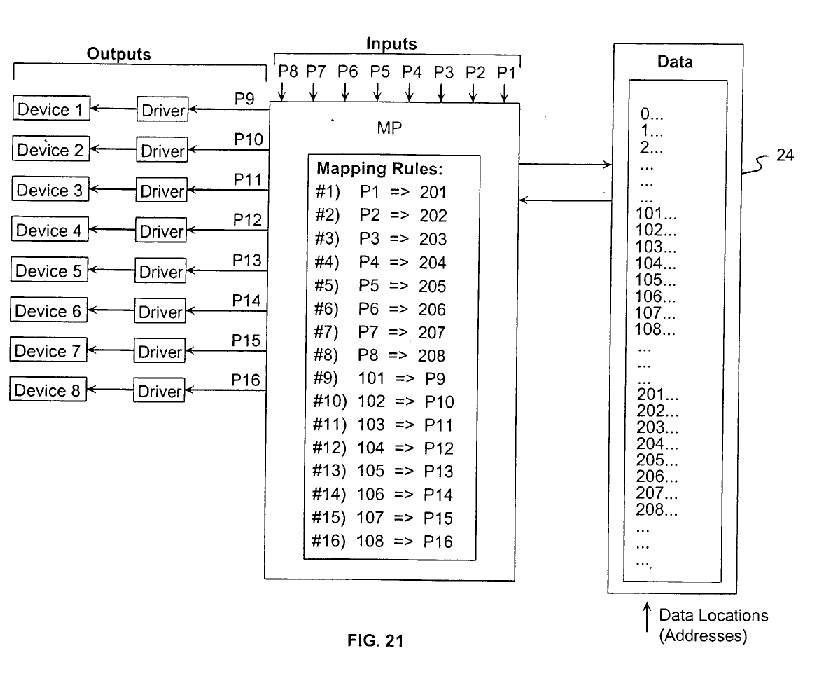

6. FIG. 21 is an alternate view of FIG. 7. FIG. 21 shows eight addresses 201-208 contained in memory 24 which are mapped to inputs P1-P8 by Mapping Rules #1 to #8 28. It also shows eight addresses 101-108 contained in memory 24 which are mapped to outputs P9-P16 by Mapping Rules #9 to #16.

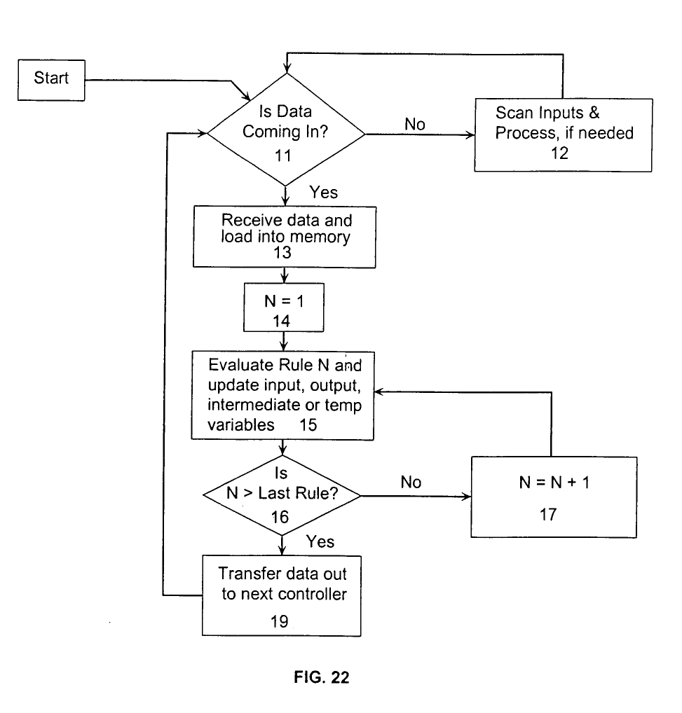

7. FIG. 22 is a flow chart illustrating a program which microprocessor MP in FIG. 21 can utilize in connection with memory 24, to control the DEVICEs in FIG. 21. That program with its rules, in effect, transfers the bits in memory 24 in FIG. 21 to the output pins P9, P10, . . . P16 of the microprocessor MP. The transfer follows the rules as shown: the bit at address 101 is transferred to pin P9; the bit at address 102 is transferred to pin P10, and so on.

Block 11 in FIG. 22 inquires whether data has started coming in from the prior controller in the system. If not, block 12 is processed to handle any input operations needed to refresh data from its own input pins. When the data stream does arrive, control passes to block 13 where the data from the prior controller is received, verified and loaded into memory 24 in FIG. 21. Then in block 14, an index N is initialized to unity. With N presently set at unity, block 15 evaluates the first rule; reading the input pin P1 and transferring it to the data bit in memory at address 201.

Decision block 16 inquires whether index N has reached a value corresponding to the last rule. If not, the NO branch is taken, the index N is incremented in block 17, and the logic returns to block 15. If index N has reached the last rule, the YES branch is taken, the logic moves to block 19, wherein the data in memory is transferred out to the next controller in the system. Control then returns back to block 11.

The overall effect of the program of FIG. 22 together with the rules from FIG. 21, is to copy the data from the input pins P1-P8 to addresses 201 to 208 in memory 24; and to copy the data contained in memory 24 in FIG. 21 from address 101 to pin P1, from address 102 to pin P2, and so on to address 108, which is written to pin P8.

Many microprocessors are designed so that their output pins hold the data which is written to them. If for some reason the data is not held by a given microprocessor, then latches can be added to the DRIVERs in FIG. 21.

Programming rules are not limited to simple MOVE-statements, where data is moved from one location to another; any feasible logical construct can be used and intermediate outputs can be updated, not just physical outputs. These intermediate outputs are carried with the rest of the data and can then be used in logical rules on the same or on other controllers in the system. The prior example associated with FIGS. 19 and 20 showed how one intermediate bit V1 was used to make switch S25 pulse on then off whenever input bit A3 was changed. In similar ways, intermediate variables can be used to debounce switch contacts, time output pulses, handle error or exception conditions, and distribute the processing load between the nodes or microprocessors in the system.

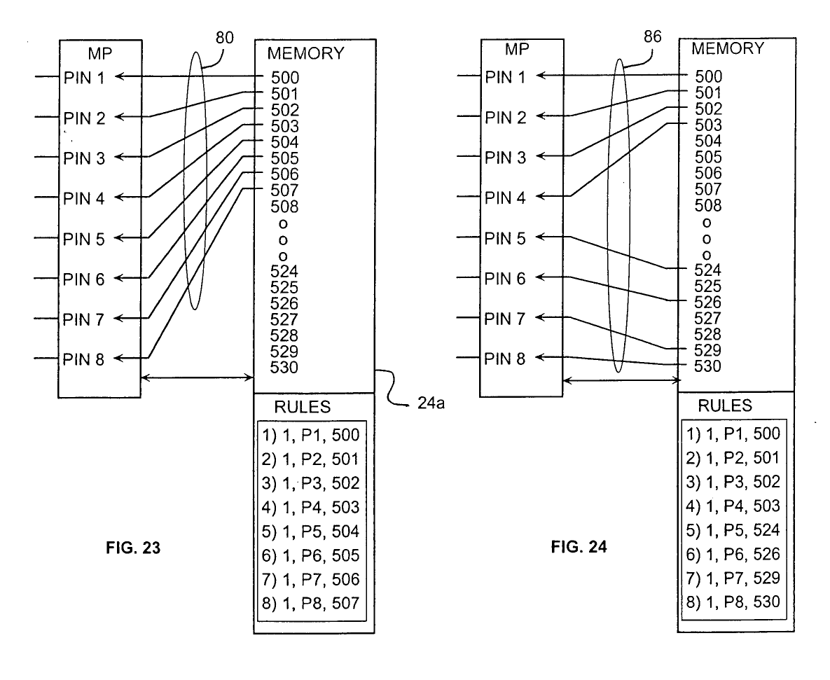

8. FIGS. 23 and 24 illustrate another approach which eliminates the requirement of loading a new program. FIG. 23 illustrates a microprocessor MP and its associated memory 24a. In addition to the data in memory 24a, the mapping information 24b is stored in other memory accessible to the microprocessor MP.

That mapping data 24b is stored symbolically in the form of logical operation and symbolic data items. It is known in the art how to write a program which evaluates the data in memory 24a, as instructed by mapping data 24b. In this example each rule has three values, an operation, an output or dependent variable and a data location or independent variable, respectively.

The operation is shown as 1 in each of these rules is associated with the move or equate logical operation in this example. The second value, output, is shown in this example, to be each of the output pins in sequence. The third value in this example is the variable or data location which holds the value to be moved or copied. In the example of FIG. 23:

| | |
|---|---|
| Rule #1) | 1, P1, 500 (copy the value in bit 500 to output P1) |
| Rule #2) | 1, P2, 501 (copy the value in bit 501 to output P2) |
| | ∘ |
| | ∘ |
| | ∘ |
| Rule #7) | 1, P7, 506 (copy the value in bit 506 to output P7) |
| Rule #8) | 1, P8, 507 (copy the value in bit 507 to output P8) |

FIG. 24 illustrates how a different mapping can be implemented. Mapping data 80 has now changed in content. Arrows 86 illustrate graphically the mapping.

Under the arrangement of FIGS. 23 and 24, the memory addresses which control each output pin of the microprocessor MP can be changed by the mapping data 80 or 86.

The Inventor observes that the mapping data 80 can also be used to write data to intermediate variables in memory 24, to thereby change the data located at the memory addresses which are mapped as indicated in FIG. 23. For example, additional rules, such as
Rule #9) 1, 520, 500
   would mean that the data bit at address 520 is to be set to the value of the data bit at address 500. Note that it was also transferred to output pin 1 in the first rule.

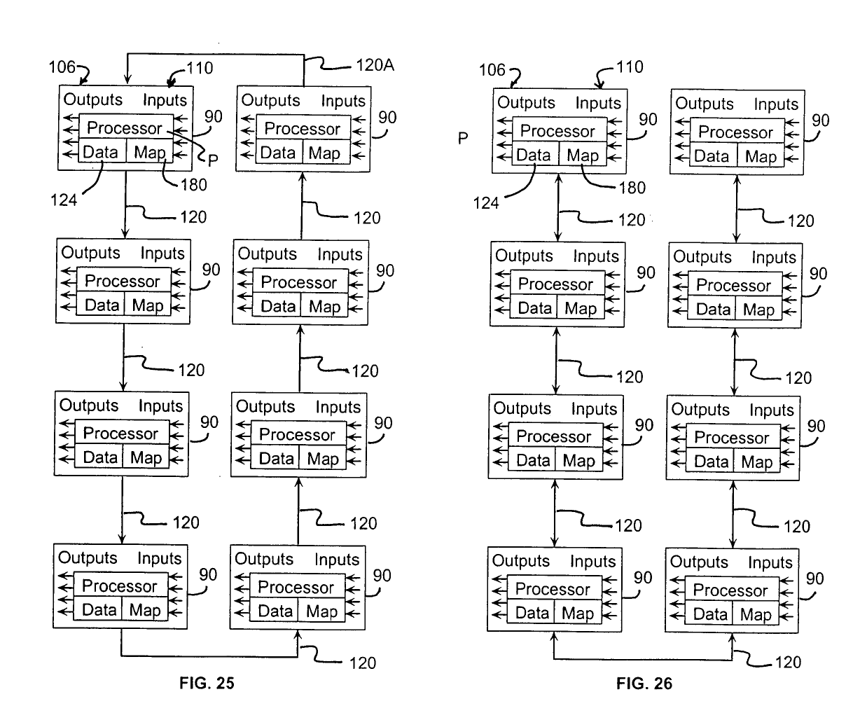

9. FIG. 25 illustrates one form of the invention, wherein eight structures 90 are connected together in the form of a ring, by communication links 120 and 120A. In one form of the invention, the structures 90 are identical in the sense that they all contain identical hardware and programming.

Thus, when an article using the invention is manufactured, identical or similar structures 90 are installed at various points throughout the article, including the embedded programming in each structure 90. Later, the content of the data 124 and the maps 180 will be supplied.

In FIG. 26 the communication link 120A has been removed and the links 120 changed from unidirectional to bidirectional, to illustrate a linear topology, in the network sense. Here the database travels back and forth across the linear network instead of traveling in a circle as shown in FIG. 25, which shows the ring network structure.

The structures 90 operate as described above: each memory 124 contains data bits at addresses, and each processor operates on those bits and on its output pins, as instructed by its map 180.

The data in memory 124 circulates around through the controllers, changing as it goes. From this point on it will be known as the database. It contains data bits representing all of the outputs, inputs and intermediate variables that are implemented in a given instance of the system.

10. The data in memory 124 in FIG. 26 circulates around through the controllers, changing as it goes. It contains data bits representing all of the outputs, inputs and intermediate variables that are implemented in a given instance of the system.

As explained above, the map 180 can be loaded or installed when the programming is loaded into the microprocessor flash or PROM memory, and another approach to loading the map 180 will be discussed now.

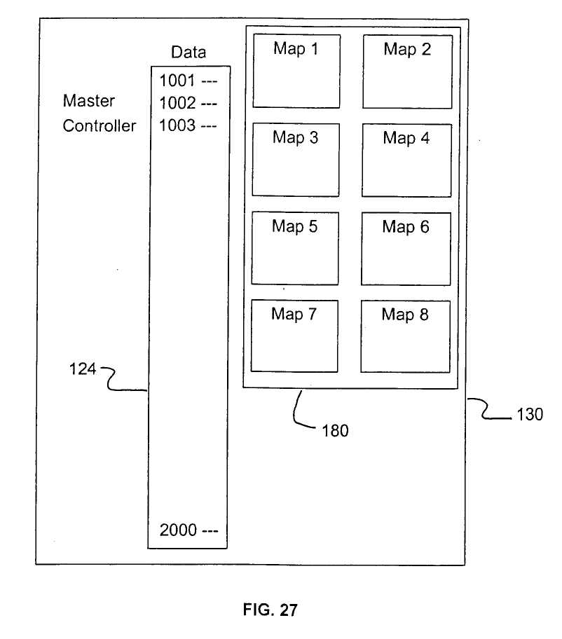

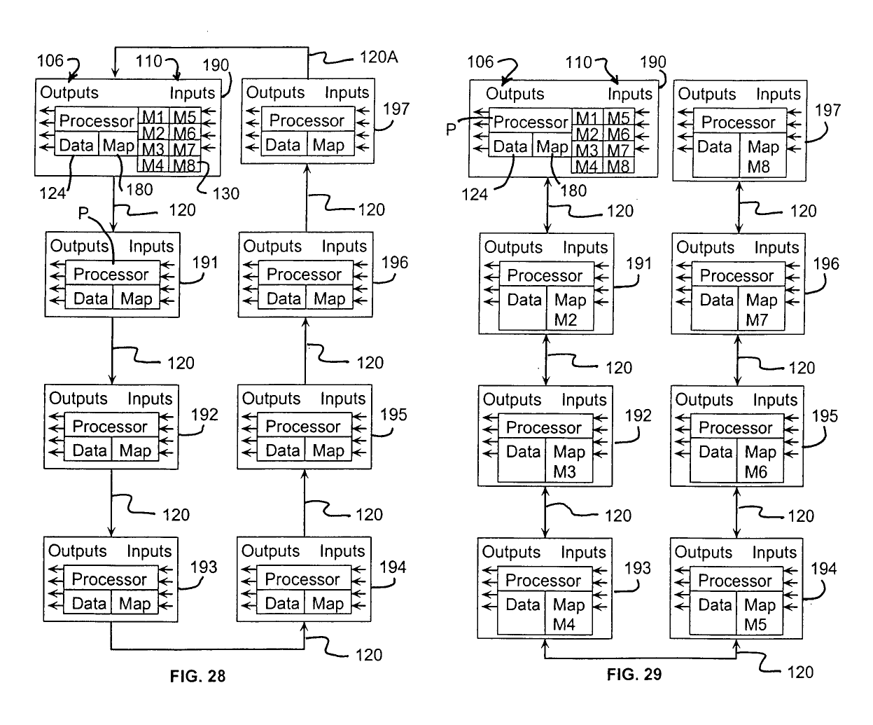

In one embodiment of the invention, covered graphically in FIGS. 27-29 where FIG. 27 illustrates schematically the memory 130 of a master controller, which contains data 124 and mapping data 180. The mapping data is subdivided into groups, labeled MAP1, MAP2, and so on. Each group corresponds to a specific controller or processor P in FIG. 28.

At startup, after a power on sequence, each individual mapping is transmitted from the master controller 190 over the communication links to the corresponding processor in each other controller 191 in sequence. Thus, as shown in FIG. 29, all the maps are sent to their proper locations whenever power is applied and only the master processor contains a non-volatile copy of the mappings.

This makes it easy to utilize more generic processor nodes throughout an automobile or other vehicle because only the master node needs to be programmed with the mappings for a specific model of automobile. The other processor nodes can be generic across many models of vehicles.

To repeat: a single master processor, specific to the particular model of automobile (or other system), is used. The other processors are generic, and can be used in any similar model. The other processors are, in effect, programmed at power up by the mapping and data received from the master processor.

Another method would be to send an initial query from the master node at startup or on command to determine if any nodes had been replaced or erased; if so, then the master node 190 would send a new copy of the mapping for that controller 191. An alternate version of this method would utilize a PC or laptop computer to sequentially download the mapping information through a temporary connection to the controllers in the system with each controller holding its mapping information continuously in non-volatile memary. Still another method would be to do all mapping operations, except the 1 to 1 output and input mapping, in the master node itself.

Therefore, as so far explained, a master controller memory 130 in FIG. 27 is generated or configured either in a master node or in a PC or other computer. It contains locations for data 124, at addresses such as 1001, 1002, etc. The master controller memory 130 also contains mapping data groups MAP1, MAP2 . . . MAP8. Each group corresponds to a single processor, and that correspondence is determined either by the sequence of the processor in the network or by a number preset in each controller.

11. The database 124 in FIG. 29 circulates rapidly over time, and the data items change at rates that depend on the particular system in which it is installed. For example, if the system is an automobile, and the database 130 indicates desired status of components such as lights, door locks, powered windows, the database may only circulate 10 to 20 times per second.

For instance, a given processor in FIG. 28 may be assigned to monitor a headlamp switch, in the dashboard of a car, and under control of the driver. When the switch calls for full headlights, that processor detects that event, modifies the database 130 accordingly, and continues on to circulate the modified database 130.

As the database moves from one processor to the next and all processors replace their copies of the database, the new value for the headlamp switch will also be replaced in each processor. At some processor(s) in the system, the new headlight data value will be used, perhaps in conjunction with other data elements such as high-beam to turn on the appropriate output and corresponding headlamp(s).

12. The Inventor points out that, 1) in the embodiment of FIG. 29, every processor has access to the entire database 124 of FIG. 27, even though every processor does not necessarily need the entire contents of the database 124 and 2) the entire database traverses the network many times a second.

In an automobile, which might utilize shielded twisted-pair wire for the communications media, the total system cycle time might be around 10 to 20 times a second; whereas, a machine or an aircraft might use fiber optic media together with high-speed fiber interfaces and processors which could allow for total system cycle rates up to 1000 times a second or beyond. The total system cycle time is relatively constant because the same amount of data is being transferred, only slight variations in the processing time for the mapping functions would be present. This makes for a very fast, very stable, deterministic networked system.

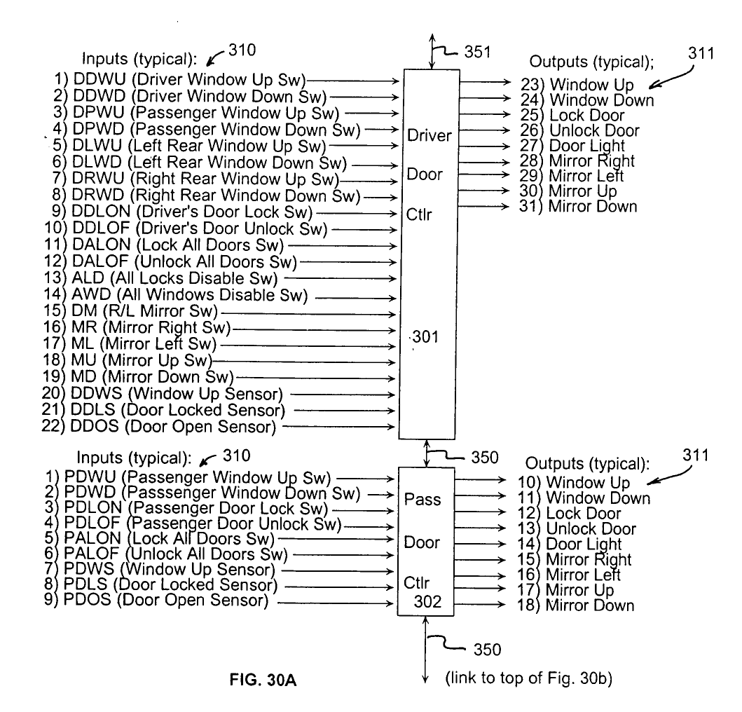

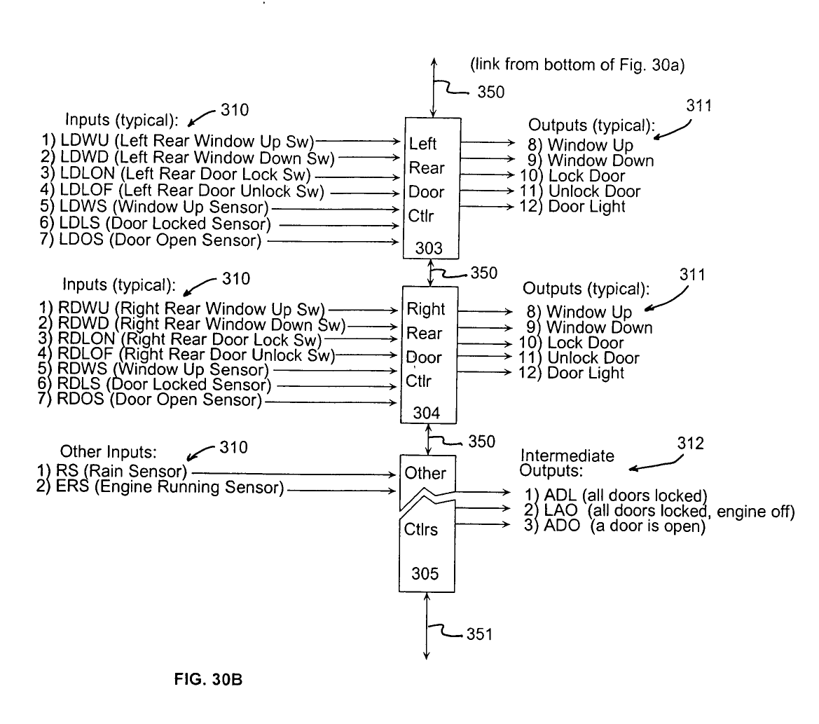

FIGS. 30A and 30B offer an example of four controller nodes 301-304 which could operate in the doors of a modern automobile. An exemplary list of typical inputs 310, outputs 311, and intermediate outputs 312 is shown as are the communication links 350 between the controllers 301-305 and communication links 351 to other controllers not shown. Each of these controllers would be connected to the switches and buttons located on its respective door.

In fact, high-current switches and buttons used currently, could be replaced with small touch buttons manufactured on a printed circuit board. Such a board could also hold the microprocessor and other circuitry and connectors for power, communications, outputs and other inputs providing a significant savings not only in wire but also in switches and labor.

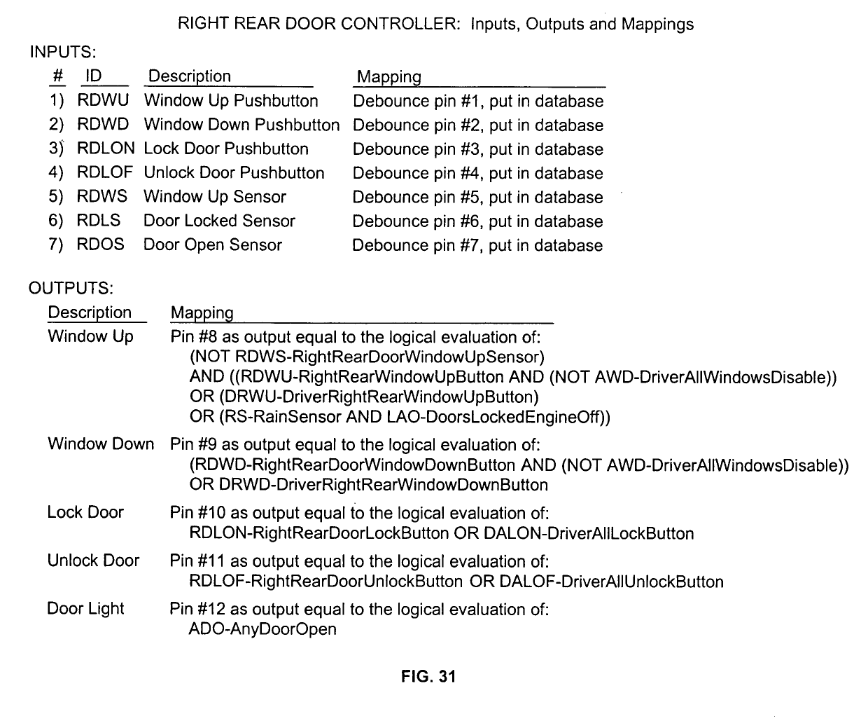

FIG. 31 is a listing of the inputs and outputs for the right rear door controller 304 shown in FIG. 30B together with examples of mapping for each input and output. It can be noted in FIG. 31 that all inputs from switches and buttons are debounced before they are entered into the database. This is necessary for mechanical switches because they tend to be electrically noisy when closing and opening because the contacts slide across each other for a brief period. Modern digital circuits are fast enough to sense each spike of “noise” as a separate contact event and interpret many openings and closings when, in fact, there was only one.

Each of the outputs listed in FIG. 31, except the Door Light, is mapped as a logical condition of two or more bits in the database. Even the relatively simple Window Up output is computed from five different inputs and one intermediate variable. This illustrates another benefit from the invention which is the relative ease, and therefore low cost, to add other inputs or variables to the system without having to add more wire, relays and the like. For example the mapping for the Window Up output includes a rain sensor input which will put the window up if the automobile is off, locked and rain is sensed. Only a rain sensor need be added and wired to a nearby controller input somewhere in the vehicle to get this function; that one input can easily control all the windows in the vehicle without additional relays or wiring to the doors.

13. The database described in this invention can also contain additional information, beyond bits representing the states of the input and output pins and intermediate bit variables. The logic states of internal variables in the processors can be recorded, as for example counter registers, time and/or date registers.

14. The inputs and outputs shown in the prior examples need not be single-bit type. Analog-to-digital conversion can be done, so that an analog signal, such as that produced by a potentiometer (not shown) can be converted to a digital signal, which would be received on multiple input lines. The multi-bit data can be stored in the database. Other analog values like position registers, time registers, counters and the like can also be used as inputs, outputs or intermediate variables.

15. Constants can also be used as inputs or intermediate variables, whether fixed from a rule or input from some device, they could be stored in the database and used for comparisons with other variables. One example would be a constant containing the desired temperature and a variable containing the current measured temperature. Rules would exist for over- and/or under-temperature conditions which would set the values for appropriate output pins.

16. In the discussions above, it was stated that the logic states of output pins of a processor were each determined by a bit in memory. However, in the general case, each processor is equipped with logic functions for transforming and mapping some or all of its input and output pins and may include logic functions which only map to intermediate or temporary variables. Intermediate variables are ones that will be held in the database and will be available to other controllers for use in their logic functions. Temporary variables will only be used and available to the assigned controller; they will not be available to other controllers.

17. The logic functions discussed so far, in general, are not limited to Boolean functions. Equations, algorithms, input smoothing functions, or other processes which receive inputs and produce one or more outputs in response are all feasible as transformation/mapping rules. The logic functions indicate how selected data within the database, or elsewhere, is mapped onto each output pin, intermediate variable or temporary variable.

18. In one form of the invention, the database contains a summary of the collected states of a system. All input pins, output pins, and intermediate variables of all processors are contained in the database. The data about the other processors will indicate significant information about the system. For example, if temperature is to be controlled, then a temperature sensor will provide an input to some processor. The database makes that temperature input available to all other processors. In general, most, if not all, measured system parameters will be applied as inputs to some processor, and thereby become part of the shared database.

19. In one form of the invention, the logic functions allow any processor to compute a selected algorithm, using any of the system variables in the database as inputs as well as internal temporary or scratchpad variables available only to that processor.

20. Logic functions can operate over time. For example, it may accept a collection of inputs at a given time T1. Then it may accept another collection of inputs at a later time T2. The output depends on both collections of inputs. The de-bouncing of contacts, described in Additional Consideration number 8, above, provides an example.

21. In one embodiment, one processor acts as a master, and controls the database. All other processors merely follow instructions provided in the database, simply mapping inputs onto the database and mapping outputs from the database onto their output pins; they do not evaluate any transformation/mapping rules themselves. For example, a collection of lights in a vehicle may be controlled by switches on a panel at the driver's, or pilot's, station. Those switches are inputs to a local processor. The master processor will apply its rules to the inputs carried in the database, which include the ones described, and set intermediate bits in the database as a result. Other processors then simply use those intermediate bit variables, carried in the database, to control the lights. But the other processors do not handle any complex rules other than possibly contact debouncing, and they will map their inputs onto the database.

22. Using intermediate or temporary variables, a system of controllers may accumulate data before providing output(s). For example, an intermediate integer variable may be used as a counter and maintain a count of the pulses seen at one or more inputs. The resulting counter could then be supplied to an intelligent device.

23. Using complex logical rules, multiple inputs can be “and'ed” or “or'ed” together logically. An output can be set on if all indicated inputs are on; indicating, for example, that all clamps have closed on a machine or doors on a vehicle. Likewise, an output can be set on if any one of a set of inputs is on (or off) as could be done for fault or error conditions.

24. In previous discussions, the inputs and outputs have been described as “pins” and have been implied to be physical input pins or output pins. In one embodiment of the invention, one or more of the controllers could be constructed on an adapter card which is plugged into a PC or other computer processor. In such instances the physical inputs and outputs could be replaced with virtual bits and words passed via the computer's bus structure to routines or programs running within the computer. Such an embodiment could also communicate with a PC or other processor via a USB or other port as opposed to being directly “plugged” into the motherboard.

25. In one embodiment, the database can be subdivided into two or more independent parts which would be circulated separately, one behind the other over the communication network. This would decrease the cycle time for each individual part of the database and, therefore increase the total system cycle rate. The transformation/mapping rules would have to be divided into independent parts as well and a database designator variable would have to be added to each database part to indicate to each processor which data it contained and which set of rules should be applied.

26. Redundant data or check values can be added to data transmission from one processor to the next. These various techniques are well known to the profession and have been assumed as a necessary part of any implementation. Such techniques are almost transparent to the operation of the invention. In one embodiment, the sole provision that could be required would be one or more fault variables and corresponding fault output pin(s). All processors would set the fault variable(s) when transmission or other errors were detected and one or more processors would provide a fault signal output for intervention and/or shutdown.

In addition to incorporating redundant data and check values, multiple parallel communications links can be utilized in situations like aircraft where failure cannot be tolerated. These could be fiber optic links that are routed over different paths in order to minimize the possibility of disruption. In such embodiments, the communication handlers would check and verify the data coming over the different communication links. Such handlers would also sense when a link went down, stop utilizing it, and generate a fault signal.

It is also envisioned by the inventor that multiple processors or multiple systems could be slaved together in parallel to provide totally redundant data paths for critical systems.

27. The Inventor points out that engineers and computer scientists use the term “database” in different ways, depending on context. In some contexts, database refers to data which is organized according to a schema. For example, a telephone directory is a type of database. In other contexts, database refers to the style of organization, or format, of the data. For example, a collection of blank income tax forms would represent such a database: the data would be supplied by the tax payers.

Thus, a packet of data which is transferred between two controllers can be termed a database because of the format of the data. For example, data items 1 through 10 in the packet represent specific items, such as specific sensor outputs. In the previous example, the specific values of the sensor outputs would represent the data.

28. In one form of the invention, after the database arrives at a controller, the controller takes specific action. Prior to arrival, the controller was idle, at least with respect to the database, meaning that the controller was not changing content of the database or outputs.

Upon arrival of the database, the controller becomes active with respect to the database. It (1) reads data from the database; (2) utilizes that data, and other data such as inputs of the controller, as inputs to algorithms which the controller runs; (3) produces output of the algorithms, and uses the output to control hardware; (4) modifies the database in accordance with the algorithms; (5) transfers the modified database to the next controller; and (6) becomes inactive again, at least with respect to the database. The next controller repeats the process, and the process continues through all controllers.

The Inventor points out that, in one form of the invention, only one controller is active at any time. That activated controller is the controller which has just received the database.

All other controllers are idle, or dormant. They are idle at least with respect to the database, meaning that they are not modifying the database or outputs. They could, however, be performing housekeeping tasks, such as refreshing memory, polling sensor inputs to keep the recorded sensor inputs current, or other computing functions.

Thus, in a sense, the database acts as a token. The token database is passed from controller-to-controller, one-at-a-time. Arrival of the token database activates the receiving controller. The activated controller takes what it needs from the token database, performs processing, controls hardware in accordance with the processing, loads data resulting from the processing into the token, passes the token database to the next controller, and then goes inactive.

The token is effectively passed to each controller exactly once in a cycle when the controller receives the database.

29. In one form of the invention, some controllers require input data which is not available to them locally. That input data is obtained from the circulating database, and may be supplied by another controller.

It is contemplated that, in some embodiments, some controllers may control no hardware, but may be assigned the sole function of collecting data for insertion into the circulating database.

30. It was stated that hardware is controlled by the controllers. It is recognized that this hardware includes other controllers or computers, so that data obtained from the database can be relayed by a controller to an agency which performs pure computation, such as a computer.

31. Various forms of the invention perform the following functions. Replaces wiring in land, water and aerospace vehicles, reducing vehicle weight and cost.

Replaces control wiring in machines and buildings.

Reduces wiring complexity and labor in vehicles, machines and buildings; at the same time allowing for more complexity in the signals. Furthermore, redundancy can be easily added for systems that need it.

Provides signal conversion and combination along with signal transfer, eliminating the need for relays and controllers in some applications; and can often provide the interface needed to tie disparate controllers together to operate in a single cell or application. Multiple inputs can be tied together with boolean logic to provide a single signal output derived from many inputs. (Example: multiple Emergency Stop Buttons tied with multiple limit switches to provide an Emergency Stop signal to machines and possibly multiple Emergency Stop signals to various controllers and components on a machine.) Likewise, one input signal can be used in the determination of multiple output signals.

Allows for replacement of heavy current and/or high voltage switches, relays and wiring with inexpensive low-voltage, low-current switches. In many applications, like automotive, the existing heavy-current switches can be replaced with tactile, “blister” switches, or other switches which are much lower in cost.

Provides deterministic performance with low variance and fast signal transfer between all inputs and outputs in the system.

Can be designed for fault-tolerant operation with multiple communications links in parallel and even with multiple controllers operated in parallel configurations. Both communication links and controllers can be situated in different areas of a vehicle to enhance survivability.

Easy to reconfigure a system, without rewiring; and easy to add signals and controllers to a system.

Numerous substitutions and modifications can be undertaken without departing from the true spirit and scope of the invention. What is desired to be secured by Letters Patent is the invention as defined in the following claims.

1. A method of operating a group of controllers, comprising:
a) maintaining a shared database, circulating through all controllers in sequence;
b) at each controller, when the shared database arrives,
i) modifying the shared database; and
ii) transferring the modified shared database to another controller in the sequence.

2. Method according to claim 1, and when the modified shared database arrives at the other controller in the sequence,
a) modifying the modified shared database; and
b) transferring the twice-modified shared database to a third controller in the sequence.

3. Method according to claim 1, wherein one or more controllers use their inputs as data to modify a subset of the shared database.

4. Method according to claim 1, wherein one or more controllers use a subset of the modified shared database to control outputs or devices.

5. Method according to claim 1, wherein each controller uses a different subset of the shared database.

6. Method according to claim 1, wherein no controllers modify or utilize the shared database except the controller which has just received the circulating database.

7. Method according to claim 1, wherein (1) a subset of the circulating database is used as input to one or more algorithms run by the controller, (2) the algorithms produce output, and (3) the output is used in modifying the shared database.

8. Method according to claim 7, wherein the output is used to control outputs or devices.

9. In a system wherein N controllers each control states of their own hardware devices, a method comprising:
a) at all times, causing
i) (N-1) controllers to be idle, with respect to the database, wherein they hold the output states of their devices constant, and
ii) a single controller to be an active controller, with respect to the database; and
b) delivering a shared database to an inactive controller A, and causing controller A to become active, with respect to the database, and to
i) insert status data into the shared database, to create a modified shared database II;
ii) utilize part of the modified shared database II as instructions for controlling devices;
iii) transmit modified shared database II to another controller; and
iv) become an inactive controller, with respect to the database.

10. Method according to claim 9, and further comprising:
c) delivering modified shared database II to inactive controller B, causing controller B to become active, with respect to the database and to
i) insert status data into modified shared database II, creating modified shared database III;
i) utilize part of the modified shared database III as instructions for controlling devices;
iii) transmit modified shared database III to another controller; and
Iv) become an inactive controller, with respect to the database.

11. Method according to claim 10, wherein (1) the part of the database used as instructions for controlling devices was applied as input to algorithms and (2) output of the algorithms is used as the status data.

12. In a system wherein (1) multiple controllers control hardware devices, (2) at least one controller requires information which is not available locally at that controller, a method comprising:
a) circulating a single shared database among the controllers in sequence, wherein each controller, upon receiving the database
i) inserts into the database data needed by other controllers,
ii) acts upon part of the database, and
iii) passes the shared database to another controller.

13. Method according to claim 12, wherein some or all of the hardware devices controlled by the controllers are software devices, programs or routines.

14. Method according to claim 12, wherein the shared database contains information which is not needed by some controllers.

15.-25. (canceled)

26. A method, comprising:
a) maintaining a collection of controllers which control devices through inputs and outputs;
b) maintaining one database, which is circulated continuously around to each controller; and
c) maintaining a mapping scheme for at least one controller which
i) identifies a subset of data in the database;
ii) specifies a logic function to which the subset is to be applied as inputs; and
iii) specifies where output of the logic function is to be sent or placed.

27. Method according to claim 26, wherein the database contains data indicating one or more of the following:
i) states of output pins of controllers;
ii) states of input pins of controllers;
iii) values of internal variables computed by controllers; and
iv) values of measured parameters in the system.

28. (cancelled)

29. Method according to claim 26, wherein two or more controllers have different mapping schemes, which have been established by one or more of the following:
i) pre-programming into some form of PROM (Programmable Read-Only Memory), wherein the mapping functions are inherent to the controller,
ii) pre-programming through a configuration process into some form of EPROM (Erasable Programmable Read-Only Memory), wherein the mapping functions are inherent to the controller but changeable through reconfiguration, and
iii) pre-programming, by a master controller at startup whenever the power is turned on, into some form of RAM (Random Access Memory), wherein the mapping functions are inherent only to the master controller.

30.-39. (canceled)

40. A method according to claim 1, and further comprising:
i) when the shared database arrives, using a subset of the shared database as instructions for controlling devices.

41. Method according to claim 2, and further comprising:
i) when the modified shared database arrives at the other controller in the sequence, using a subset of the modified shared database as instructions for controlling devices.

42. Method according to claim 41, wherein each controller uses a different subset of the shared database.

43. In a system wherein N controllers each control states of their own hardware devices, a method comprising:
a) at all times, causing
i) (N-1) controllers to be idle, wherein they hold states of their devices constant, and
i) a single controller to be an active controller; and
b) delivering a shared database to an active controller A, and causing active controller A to
i) utilize part of the shared database as instructions for controlling devices;
ii) insert status data into the shared database, to create a shared database II;
iii) transmit shared database II to another controller; and
iv) become an inactive controller.

44. Method according to claim 43, and further comprising:
c) delivering shared database II to an active controller B, causing active controller B to
i) utilize part of the shared database II as instructions for controlling devices;
ii) insert status data into shared database II, to create a shared database III;
iii) transmit shared database III to another controller; and
iv) become an inactive controller.

45. Method according to claim 43, wherein (1) the part of the database used as instructions for controlling devices was applied as input to algorithms and (2) output of the algorithms is used as the status data.

46.-50. (canceled)
